(19) United States
(12) Patent Application Publication
(10) Pub. No.: US 2024/0181404 A1
(43) Pub. Date: Jun. 6, 2024

(54) CROSS-LINKED ZWITTERIONIC POLYMER NETWORK AND THEIR USE IN MEMBRANE FILTERS

(71) Applicant: Trustees of Tufts College, Medford, MA (US)

(72) Inventors: Ayse Asatekin Alexiou, Arlington, MA (US); Abhishek Narayan Mondal, Medford, MA (US); Samuel J. Lounder, Somerville, MA (US)

(21) Appl. No.: 18/287,515

(22) PCT Filed: Apr. 22, 2022
(86) PCT No.: PCT/US22/25981

§ 371 Date: Oct. 19, 2023

Related U.S. Application Data
(60) Provisional application No. 63/178,072, filed on Apr. 22, 2021.

(51) Int. Cl. B01D 71/40; B01D 69/02; B01D 69/12; B01D 71/44; B01D 71/82; C08F 220/24; C08F 220/40; C08F 228/02; C08F 230/02; C08K 5/37

(52) U.S. Cl. CPC B01D 71/40; B01D 69/02; B01D 69/125; B01D 71/44; B01D 71/82; C08F 220/24; C08F 220/40; C08F 228/02; C08F 230/02; C08K 5/37; B01D 2323/30; B01D 2323/345; B01D 2325/02831; B01D 2325/02832; B01D 2325/04; B01D 2325/18; B01D 2325/34

(57) ABSTRACT

Disclosed are crosslinked copolymer network, comprising a copolymer, comprising a plurality of zwitterionic repeat units, and a plurality of a first type of hydrophobic repeat units; a plurality of crosslinking units; and a plurality of crosslinks; wherein each crosslinking unit comprises a first terminal thiol moiety and a second terminal thiol moiety; each hydrophobic repeat unit comprises an alkene; and each crosslink is formed from (i) the first terminal thiol moiety of a crosslinking unit and the alkene of a first hydrophobic repeat unit, and (i) the second terminal thiol moiety of the crosslinking unit and the alkene of a second hydrophobic repeat unit; and the method of making such cross-linked copolymer network. Also disclosed are the thin film composite membrane comprising the cross-linked copolymer network; and methods for using such thin film composite membrane.

### RELATED APPLICATION

This application claims the benefit of priority to U.S. Provisional Application No. 63/178,072, filed Apr. 22, 2021; the contents of which are incorporated by reference.

### GOVERNMENT SUPPORT

This invention was made with government support under grant DE-FE0031851 awarded by the United States Department of Energy, and grant 1553661 awarded by the National Science Foundation. The government has certain rights in the invention.

### BACKGROUND

Membrane filtration is an important and promising method of water purification, reclamation and reuse. Membranes of various pore sizes can be used for a wide range of objectives, from simply removing disease-causing microorganisms to desalination by reverse osmosis (RO). Membranes also serve as an efficient, simple, scalable separation method in various industries, such as food, beverage, dairy, and bio/pharmaceutical industries.

Membranes with improved selectivity, or ability to separate solutes with better precision, offer to improve the economic feasibility and energy efficiency of several other processes. For instance, membranes with improved selectivity between sulfate and chloride anions could alter the composition of seawater and wastewater for use as drilling fluid in offshore oil wells while operating at lower applied pressures. Membranes with extremely small pore sizes but low salt rejection can lead to highly improved effluent quality for challenging wastewater streams, particularly those with high organic content, such as those from the food industry.

All of the aforementioned membrane processes are often severely impacted by fouling, defined as the degradation of membrane performance due to the adsorption and accumulation of feed components on the membrane surface. Severe declines in membrane permeability and changes in membrane selectivity are common. Fouling management is a significant component of costs associated with membrane systems, requiring increased energy use, regular cleanings involving downtime, maintenance and chemical use, and more complex processes.

### SUMMARY

Provided herein are crosslinked copolymer networks designed to create membranes with tunable size based selectivity for small organic molecules and selectivity between dissolved ions.

In an aspect, disclosed is a crosslinked copolymer network, comprising:
a copolymer, comprising a plurality of zwitterionic repeat units, and a plurality of a first type of hydrophobic repeat units;
a plurality of crosslinking units; and
a plurality of crosslinks;
wherein each crosslinking unit comprises a first terminal thiol moiety and a second terminal thiol moiety; each hydrophobic repeat unit comprises an alkene; and each crosslink is formed from (i) the first terminal thiol moiety of a crosslinking unit and the alkene of a first hydrophobic repeat unit, and (i) the second terminal thiol moiety of the crosslinking unit and the alkene of a second hydrophobic repeat unit.

In an aspect, disclosed is a thin film composite membrane, comprising a porous substrate, and a selective layer comprising the crosslinked copolymer network disclosed herein, wherein an average effective pore size of the porous substrate is larger than an average effective pore size of the selective layer; and the selective layer is disposed on a surface of the porous substrate.

In an aspect, disclosed is a method of making the crosslinked copolymer network of disclosed herein, the method comprising:
providing a copolymer comprising a plurality of zwitterionic repeat units, and a plurality of a first type of hydrophobic repeat units; wherein each hydrophobic repeat unit comprises an alkene;
providing a plurality of crosslinking units; wherein each crosslinking unit comprises a first terminal thiol moiety and a second terminal thiol moiety;
providing a photo initiator;
admixing the copolymer, the plurality of crosslinking units, and the photo initiator, thereby forming a mixture; and
irradiating the mixture with UV light, thereby forming the crosslinked copolymer.

### BRIEF DESCRIPTION OF THE DRAWINGS

FIG. 1A is a schematic representation of a molecular self-assembly to generate bicontinuous networks of zwitterionic (shown with positive and negative charged groups) and cross-linkable hydrophobic (circles with stripes) domains. Water and smaller solutes can pass through the zwitterionic channels, while larger solutes are retained

FIGS. 1B and 1C show a synthesis scheme of a cross-linkable random zwitterionic copolymer (ZAC) and its cross-linking reaction through thiol-ene click chemistry

FIG. 1D is a NMR spectrum of structure—PAM-r-SBMA indicating copolymerization.

FIG. 1E is an IR spectrum of structure—PAM-r-SBMA indicating copolymerization.

FIG. 1F is a schematic representation of the associated UV assisted cross-linking.

FIGS. 2A-2C show SEM images, FIG. 2A shows uncoated PS-35 support membrane, FIG. 2B shows uncrosslinked (TCZ-0) membrane with the random zwitterionic support layer, and FIG. 2C shows Crosslinked (TCZ-40) membrane after immersion in TFE for 24 h. Cross-linking prevented the selective layer from dissolving in TFE, a solvent that readily dissolves the un-cross-linked copolymer. 7000× magnification.

FIG. 3A is a NMR spectrum of structure—P(AM-r-TFEMA-r-MPC) indicating copolymerization.

FIG. 3B is an IR spectrum of structure—P(AM-r-TFEMA-r-MPC) indicating copolymerization.

FIG. 4 shows rejection of anionic dyes of different molecular diameters.

FIG. 5 shows rejection of anionic dyes of different molecular diameters.

FIG. 6 shows size-based small molecule separation capability of TCZ-40 membrane was monitored when two different dyes (0.05 mM each) Chicago sky blue 6B (0.88 nm) and methyl orange (0.79 nm) were mixed together as a feed for a diafiltration experiment.

FIG. 7A is a graph of rejection in percentage versus diameter in nanometer (nm) showing the rejection of anionic dyes of varying sizes by TERP-C-0 (uncrosslinked) and TERP-C-14 (crosslinked) membranes. Both membranes showed a sharp size cut-off. Crosslinked membrane showed higher rejections than the non-crosslinked one, confirming that crosslinking leads to smaller effective pore size.

FIG. 7B is a graph of rejection in percentage versus diameter in nanometer (nm) showing the rejection performance of TERP-C-14.

FIG. 7C is a graph of absorbance versus wavelength (manometer) showing fractionation of two dyes, Chicago sky blue 6B (0.88 nm) and methyl orange (0.79 nm), by TERP-C-14, documented by the UV spectra of the feed, permeate, and each dye for reference. Only methyl orange permeates through the TERP-C-14 membrane, while Chicago sky blue 6B was completely retained.

FIGS. 8A-8C show rejection performance of 20 mM NaCl (FIG. 8A), Na₂SO₄ (FIG. 8B) and MgSO₄ (FIG. 8C) salts at various applied pressure for un-crosslinked TCZ-0 and Crosslinked TCZ membranes.

FIG. 9A shows Rejection of 20 mM Na₂SO₄ at various applied pressures for crosslinked TERP membranes.

FIG. 9B shows Rejection of 20 mM NaCl at various applied pressures for crosslinked TERP membranes.

FIGS. 10A-10C shows dead-end-filtration of foulant solutions through TCZ-30 (FIG. 10A), TCZ-40 (FIG. 10B), and a commercial membrane NP-30 (FIG. 10C).

FIGS. 11A-11B shows dead-end-filtration of foulant solutions through TCZ-40 (FIG. 11A), and a commercial membrane NP-30 (FIG. 11B).

FIG. 12A is a graph of J/J₀ versus time (hours) showing Dead-end fouling data with oil-in-water emulsion solutions for a commercial membrane NP-30, and FIG. 12B shows the data for TERP-C-14. The plots show the change in the normalized flux, defined as the ratio of flux at the given time point (J) normalized by the initial pure water flux (J₀). After stabilization of the initial water flux(blue), normalized flux during the filtration of the foulant solution is monitored (circles). Then, the membrane is rinsed with water several times, and normalized water flux is measured again (cones). TERP-C-14 membrane show no flux loss during and after exposure to foulant solutions, whereas the commercial membrane shows significant (˜48%) irreversible flux loss. The foulant solution was composed of 1500 mg/L oil-in-water (9:1) emulsion. J₀=2.75 L m⁻² hr⁻¹ for all membranes.

FIG. 13A is a is a graph of J/J₀ versus time (hours) showing Fouling of commercial membrane NP-30, and FIG. 13B shows the data for TERP-C-14 membranes by 1 g/L Bovine Serum Albumin in 10 mM CaCl₂ solution. TERP-C-14 membrane exhibited no flux loss during and after exposure to foulant solutions, whereas the commercial NP-30 membrane showed significant (˜27%) irreversible flux loss. J₀=2.75 L m⁻² hr⁻¹.

FIG. 14A is a SEM cross-sectional image of an uncoated PS-35 support membrane after immersion in TFE for 24 hours; FIG. 14B is a SEM cross-sectional image of an uncrosslinked (TERP-C-0) membrane as cast after immersion in TFE for 24 hours; and FIG. 14C is a SEM cross-sectional image Crosslinked TERP-C-14 membrane after immersion in TFE for 24 hours. Illustrating that cross-linking prevented the selective layer from dissolving in TFE, a solvent that easily dissolves the uncrosslinked copolymer. 7000× magnification.

FIG. 15 is a graph of % of permeance decrease versus crosslinking time in minutes showing the effect of crosslinking time on membrane permeance decrease.

FIG. 16 shows polymer, crosslinker, and photo initiator used in Examples 17-20.

FIG. 17 shows a Bright field TEM image of self-assembled nanostructure of P(AM-r-SBMA). Zwitterionic domains are positively stained with Cu²⁺ ions and appear dark. Inset shows Fast Fourier transform of the image.

FIG. 18 shows an ATR-FTIR spectra of uncross-linked (TCZ-0) and cross-linked (TCZ-40) films of random zwitterionic copolymer P(AM-r-SBMA).

FIGS. 19A and 19B show XPS spectra of TCZ-0 and TCZ-40 membranes. FIG. 19A shows Survey scans, and FIG. 19B shows high-resolution spectra for the S2p region.

FIG. 20 illustrates the effect of cross-linking time on membrane permeance decrease.

FIGS. 21A and 21B show Fouling of TCZ-30 (FIG. 21A) and TCZ-40 (FIG. 21B) membranes by 1 g L−1 BSA in PBS, demonstrated by the change in normalized water flux during foulant filtration (circles) and after rinsing with water (triangles and squares). Both TCZ-30 and TCZ-40 membranes exhibit negligible.

FIG. 22 shows a Comparison of pure water permeance for the membrane TCZ-20 before and after acid/base treatment. Membrane was dipped in 0.5 M NaOH and HCl respectively and pure water permeance was recorded afterwards to compare the data with untreated TCZ-20.

FIG. 23 shows an Image of the protein-stained commercial NP-30 and TCZ-40 membrane. NP-30 showed more protein adsorption than our TCZ-40 membrane.

### DETAILED DESCRIPTION

Disclosed is a chemical modification of zwitterion-containing amphiphilic copolymers, especially in the form of membrane selective layers, using thiol-ene click chemistry to tune the effective pore size, improve chemical, thermal, and mechanical stability, and incorporate additional functional groups.

One embodiment of the click crosslinking reaction may be represented by:
thiol (R—SH)+alkene (CH₂═CH—)->R—S—CH₂—CH₂—. In this representation, once formed the crosslink does not comprise a thiol group or an alkene; it is their reaction product. In other words, a di-thiol-containing compound may be considered a crosslinking reagent that upon reaction of its constituent thiols with alkenes of at least two hydrophobic repeat units forms a crosslink that is part of the crosslinked copolymer network.

The invention utilizes specifically designed random zwitterionic copolymers (rZACs) that comprise at least two types of repeat units:
A zwitterionic repeat unit (i.e., a moiety which holds an equal number of positive and negative charge groups).
A hydrophobic repeat unit that contains an alkene group (e.g., allyl methacrylate).

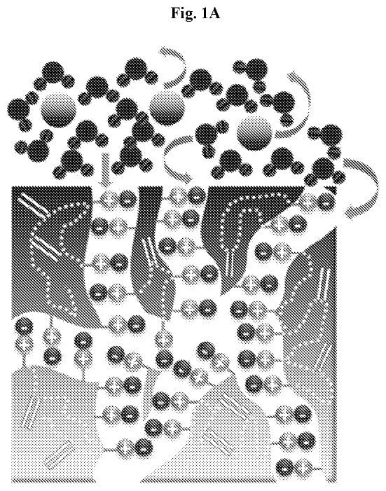

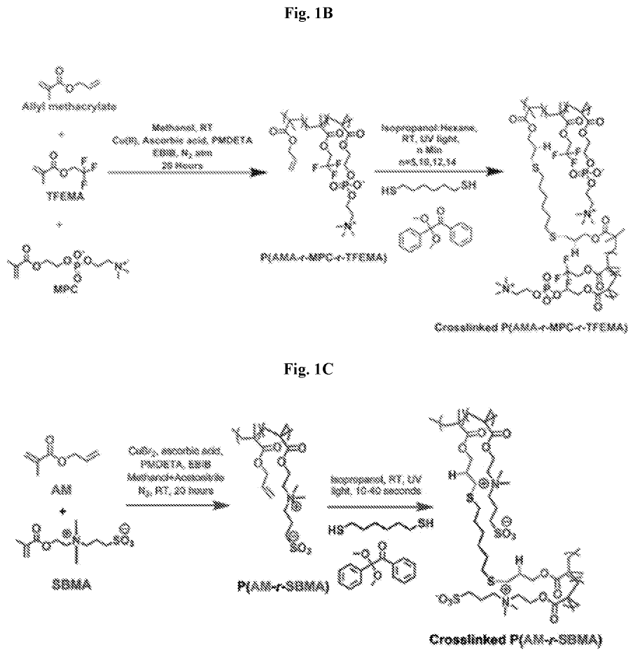

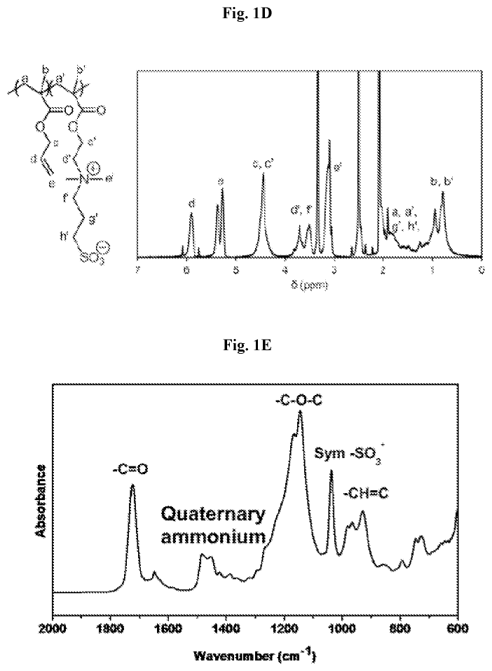

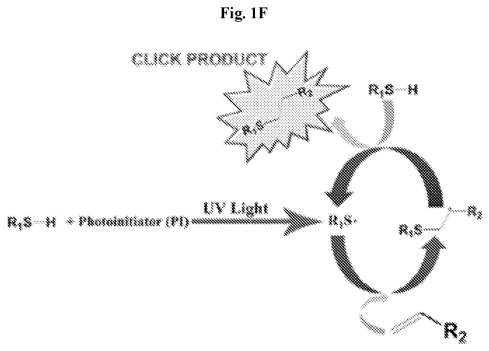

The material can also include an additional hydrophobic repeat unit that is not cross-linkable. rZACs prepared by a versatile combination of hydrophobic repeat unit (or hydrophobic) monomer with a zwitterionic repeat unit (or hydrophilic zwitterionic monomer), microphase separate to form a classic bicontinuous networks of hydrophobic and zwitterionic domains over a broad composition range. The hydrophilic zwitterionic nanodomains formed as a network composed of zwitterionic nanochannels for the permeation of water and solutes small enough to enter, bound by the hydrophobic domains of the copolymer (FIG. 1A).

These copolymers are synthesized through methods known in the field of polymer chemistry, such as atom transfer radical polymerization (ATRP) or radical addition fragmentation chain transfer (RAFT) polymerization. The invention involves forming this rZAC into a thin film composite (TFC) membrane or a thin film. The thin film is prepared by forming the rZAC into the desired shape (for example, a thin free-standing film, or a TFC membrane, which comprises an rZAC film covering a porous support), exposing rZAC to a plurality of crosslinking units, wherein each crosslinking unit comprises at least two terminal thiol moieties, for example, a thiol or dithiol, as well as a photoinitiator, and irradiating the film with UV light, which leads to a reaction between thiol groups and the alkene groups of the hydrophobic repeat unit of the copolymer (FIG. 1B). This reaction, termed thiol-ene click reaction, can be used for attaching desired functional groups to the rZAC. In one preferred embodiment, dithiols are used, and the reaction leads to the cross-linking of the copolymer. Thiol-ene “click” chemistry is characterized by very high reaction rates, high conversions and selective yields. These features make it a good choice for post-functionalization of membranes in roll-to-roll systems, where short residence times with high yields are required. Reaction mechanisms of this reaction tolerate the incorporation of a wide range of functionalities with high reliability on time scales aligned with membrane manufacturing rates. The time scales of reported thiol-ene click reactions constitute a major bottleneck for roll to roll manufacture and scale up. Disclosed is the use of rapid thiol-ene click reactions to achieve effective cross-linking of self-assembled membranes in a matter of seconds to precisely tune the pore diameter.

Also disclosed is the use of rZACs as selective layers of composite filtration membranes. In an embodiment, the rZAC is coated onto a porous support by methods well-understood in the membrane industry (e.g., doctor blade coating, spray coating). Upon deposition, the zwitterionic groups are expected to undergo self-assembly to create microphase-separated domains, or zwitterion clusters. Then the rZAC layer is cross-linked using click reaction with a cross-linking reagent with at least two thiol groups (e.g., a dithiol, a tetrathiol), leading to its cross-linking. This cross-linking leads to improved thermal and chemical stability. Importantly and unusually, cross-linking leads to a change in the effective pore size of the membrane, decreasing it to as low as about 1 nm and enabling selectivity between small molecules and between salt ions. An important and unexpected feature of this reaction is that high degrees of cross-linking and major changes in membrane selectivity can be achieved in as little as about 5-40 seconds of UV exposure. Such short time scales are important for the scalability of the technology, and significantly shorter than time scales reported for other click-based modification methods for membranes. Finally, the resultant membranes are extremely resistant to fouling, enhancing their utility in many fields including water desalination and softening, removal of metal ions and organic pollutants from water, separation of organic molecules dissolved in water, wastewater treatment including the treatment of challenging wastewater streams.

In one aspect, disclosed are crosslinked copolymer network, comprising a copolymer, comprising a plurality of zwitterionic repeat units, and a plurality of a first type of hydrophobic repeat units; a plurality of crosslinking units; and a plurality of crosslinks; wherein each crosslinking unit comprises a first terminal thiol moiety and a second terminal thiol moiety; each hydrophobic repeat unit comprises an alkene; and each crosslink is formed from (i) the first terminal thiol moiety of a crosslinking unit and the alkene of a first hydrophobic repeat unit, and (ii) the second terminal thiol moiety of the crosslinking unit and the alkene of a second hydrophobic repeat unit. In other words, in the formed crosslinked copolymer network each crosslinking unit comprises a first terminal thioether moiety and a second terminal thioether moiety; and each crosslink is formed from (i) the first terminal thiol moiety of a crosslinking reagent that has reacted with the alkene of a first hydrophobic repeat unit, and (i) the second terminal thiol moiety of the crosslinking reagent that has reacted with the alkene of a second hydrophobic repeat unit.

In certain embodiments, each of the zwitterionic repeat units independently comprises sulfobetaine, carboxybetaine, phosphorylcholine, imidazolium alkyl sulfonate, or pyridinium alkyl sulfonate. In certain embodiments, each of the zwitterionic repeat units is independently formed from sulfobetaine acrylate, sulfobetaine acrylamide, carboxybetaine acrylate, carboxybetaine methacrylate, 2-methacryloyloxyethyl phosphorylcholine, acryloxy phosphorylcholine, phosphorylcholine acrylamide, phosphorylcholine methacrylamide, carboxybetaine acrylamide, 3-(2-vinylpyridinium-1-yl)propane-1-sulfonate, 3-(4-vinylpyridinium-1-yl)propane-1-sulfonate, or sulfobetaine methacrylate.

In certain embodiments, each of the hydrophobic repeat units is independently formed from a styrene, an alkyl acrylate, an alkyl methacrylate, an alkyl acrylamide, an acrylonitrile, an aryl acrylate, an aryl methacrylate, and an aryl acrylamide.

In certain embodiments, the copolymer is poly((allyl methacrylate)-random-(sulfobetaine methacrylate)) or poly((allyl methacrylate)-random-(2-methacryloyloxyethyl phosphorylcholine)).

In certain embodiments, the crosslinked copolymer network further comprises a plurality of a second type of hydrophobic repeat units, wherein the second type of hydrophobic repeat units are each independently formed from an alkyl acrylate, a alkyl methacrylate, an alkyl acrylamide, an acrylonitrile, an aryl acrylate, an aryl methacrylate, and an aryl acrylamide. In certain embodiments, the second type of hydrophobic repeat units are formed from 2,2,2-trifluoroethyl methacrylate.

In certain embodiments, the plurality of hydrophobic repeat units comprises a carbon-carbon double bond (an alkene). In certain embodiments, the cross-linkable moiety comprises an allyl (CH₂—CH═CH₂), a vinyl (—CH═CH₂ or —CH═CH—), a vinyl ether (—O—CH═CH₂), or a vinyl ester (—CO—O—CH═CH₂).

In certain embodiments, the copolymer is poly(allyl methacrylate-random-trifluoroethyl methacrylate-random-2-methacryloyloxyethyl phosphorylcholine). In certain embodiments, the copolymer has a molecular weight of about 3,000 to about 10,000,000 Dalton, about 5,000 to about 9,000,000 Dalton, about 10,000 to about 8,000,000 Dalton, about 20,000 to about 7,000,000 Dalton, or about 10,000 to about 10,000,000 Dalton. For example, the molecular weight of about 20,000 to about 9,000,000 Dalton, about 30,000 to about 8,000,000 Dalton, about 40,000 to about 7,000,000 Dalton, about 50,000 to about 6,000,000 Dalton, about 60,000 to about 5,000,000 Dalton, about 70,000 to about 4,000,000 Dalton, about 80,000 to about 3,000,000 Dalton, about 90,000 to about 2,000,000 Dalton, about 100,000 to about 1,000,000 Dalton, about 20,000 to about 900,000 Dalton, about 20,000 to about 800,000 Dalton, about 20,000 to about 700,000 Dalton, about 20,000 to about 600,000 Dalton, about 20,000 to about 500,000 Dalton, about 20,000 to about 400,000 Dalton, about 20,000 to about 300,000 Dalton, about 20,000 to about 200,000 Dalton, or about 20,000 to about 100,000 Dalton. In certain embodiments, the copolymer has a molecular weight of about 20,000 to about 500,000 Dalton.

In certain embodiments, the zwitterionic repeat units and the hydrophobic repeat units each constitute 20-80% by weight of the copolymer. In certain embodiments, the zwitterionic repeat units constitute 25-75% by weight of the copolymer, and the hydrophobic repeat units constitute 25-75% by weight of the copolymer.

In certain embodiments, the copolymer is poly((allyl methacrylate)-random-(sulfobetaine methacrylate)), the zwitterionic repeat units constitute 25-75% by weight of the copolymer, and the copolymer has a molecular weight of about 20,000 to about 100,000 Dalton.

In certain embodiments, the copolymer is poly((allyl methacrylate)-random-(trifluoroethyl methacrylate)-random-(sulfobetaine methacrylate)), the zwitterionic repeat units constitute 25-75% by weight of the copolymer, and the copolymer has a molecular weight of about 20,000 to about 100,000 Dalton.

In certain embodiments, the copolymer is poly((allyl methacrylate)-random-(trifluoroethyl methacrylate)-random-(methacryloxyphosphorylcholine)), the zwitterionic repeat units constitute 25-75% by weight of the copolymer, and the copolymer has a molecular weight of about 20,000 to about 100,000 Dalton.

In certain embodiments, the plurality of crosslinking units is represented by FG-CL-FG, wherein FG is a linker-thiol moiety, and CL is a C₁-C₂₀ bivalent aliphatic radical, a C₁-C₂₀ bivalent heteroaliphatic radical, a bivalent aryl radical, or a bivalent heteroaryl radical. In certain embodiments, CL is a C₁-C₂₀ bivalent aliphatic radical or a C₁-C₂₀ bivalent heteroaliphatic radical. In certain embodiments, FG-CL-FG is —S—(CH₂)₆—S—, or —S—(CH₂)₂—O—(CH₂)₂—O—(CH₂)₂—S—.

In yet another aspect, disclosed are thin film composite membranes, comprising a porous substrate, and a selective layer comprising the crosslinked copolymer network disclosed herein, wherein an average effective pore size of the porous substrate is larger than an average effective pore size of the selective layer; and the selective layer is disposed on a surface of the porous substrate.

In certain embodiments, the selective layer has the average effective pore size of about 0.1 nm to about 2.0 nm. For example, the selective layer has the average effective pore size of about 0.1 nm to about 1.8 nm, about 0.1 nm to about 1.6 nm, about 0.1 nm to about 1.4 nm, about 0.1 nm to about 1.2 nm, about 0.1 nm to about 1.0 nm, about 0.1 nm to about 0.8, about 0.1 nm to about 0.6 nm, about 0.1 nm to about 0.4 nm, about 0.1 nm to about 0.2 nm, about 0.3 nm to about 2.0 nm, about 0.5 nm to about 2.0 nm, about 0.7 nm to about 2.0 nm, about 0.7 nm to about 1.2 nm, about 0.9 nm to about 2.0 nm, or about 1 nm to about 2.0 nm. In certain embodiments, the selective layer has the average effective pore size of about 0.1 nm to about 1.2 nm. In certain embodiments, the selective layer has the average effective pore size of about 0.7 nm to about 1.2 nm.

In certain embodiments, the selective layer has a thickness of about 10 nm to about 10 μm. For example, a thickness of about 20 nm to about 9 μm, about 30 nm to about 8 μm, about 40 nm to about 7 μm, about 50 nm to about 6 μm, about 60 nm to about 5 μm, about 70 nm to about 4 μm, about 80 nm to about 3 μm, about 90 nm to about 2 μm, or about 100 nm to about 1 μm. In certain embodiments, the selective layer has the thickness of about 100 nm to about 2 μm.

In certain embodiments, the thin film composite membrane rejects charged solutes and salts. In certain embodiments, the selective layer exhibits sulfonate (SO₄²⁻) rejection of greater than 95%. In certain embodiments, the selective layer exhibits chloride (Cl⁻) rejection of less than 35%. In certain embodiments, the selective layer exhibits sulfonate (SO₄²⁻)/chloride (Cl−) separation factor of greater than 50. In certain embodiments, the selective layer exhibits sulfonate (SO₄²⁻)/chloride (Cl−) separation factor of about 75.

In certain embodiments, the selective layer exhibits different anion rejections for salts with the same cation. In certain embodiments, the selective layer exhibits different anion rejections for salts selected from NaF, NaCl, NaBr, NaI, Na₂SO₄, and NaClO₄. In certain embodiments, the selective layer exhibits different rejections for different anionic dyes.

In certain embodiments, the selective layer exhibits a Chicago Sky Blue 6B/methyl orange separation factor of about 10.

In certain embodiments, the selective layer exhibits Vitamin B12 rejection of greater than about 95%. In certain embodiments, the selective layer exhibits Riboflavin rejection of greater than about 35%.

In certain embodiments, the selective layer exhibits antifouling properties. In certain embodiments, the selective layer exhibits resistance to fouling by an oil emulsion. In certain embodiments, the selective layer exhibits resistance to fouling by a Bovine Serum Albumin solution. In certain embodiments, the selective layer is stable upon exposure to chlorine bleach. In certain embodiments, the selective layer exhibits size-based selectivity between uncharged organic molecules. In certain embodiments, the selective layer exhibits rejection of >95% or >99% for neutral molecule with hydrated diameter of about or greater than 1.5 nm.

In yet another aspect, disclosed is a method of making the crosslinked copolymer network disclosed herein, the method comprising: providing a copolymer comprising a plurality of zwitterionic repeat units, and a plurality of a first type of hydrophobic repeat units; wherein each hydrophobic repeat unit comprises an alkene, and providing a plurality of crosslinking units; wherein each crosslinking unit comprises a first terminal thiol moiety and a second terminal thiol moiety; providing a photo initiator, and admixing the copolymer, the plurality of crosslinking units, and the photo initiator, thereby forming a mixture; and irradiating the mixture with UV light, thereby forming the crosslinked copolymer.

In certain embodiments, the mixture further comprises a solvent. In certain embodiments, the solvent is mixture of isopropanol and hexane. In certain embodiments, the irradiation is performed at room temperature. In certain embodiments, the photo initiator is 2-phenylacetophenone.

In certain embodiments, the irradiation is performed for about 10 seconds to about 20 minutes. In certain embodiments, the irradiation is performed for about 30 seconds. In certain embodiments, the irradiation is performed for about 60 seconds. In certain embodiments, the irradiation is performed for about 90 seconds. In certain embodiments, the irradiation is performed for about 120 seconds.

In yet another aspect, disclosed is a method of pharmaceutical manufacturing, comprising: contacting the thin film composite membrane disclosed herein with a mixture comprising one or more pharmaceutical compounds; and separating one or more pharmaceutical compounds via size-selective filtration.

In yet another aspect, disclosed is a method of textile dying and processing, comprising: contacting the thin film composite membrane disclosed herein with a mixture comprising one or more textile dyes; and separating one or more textile dyes via size-selective filtration.

In yet another aspect, disclosed is a method of buffer exchange, comprising: contacting the thin film composite membrane disclosed herein with a first buffer solution; and replacing the first buffer solution with a second buffer solution.

In yet another aspect, disclosed is a method of purifying a peptide, comprising: contacting the thin film composite membrane disclosed herein with a mixture comprising one or more peptides; and separating one or more peptides via size-selective filtration.

In yet another aspect, disclosed is a method of removing a divalent ion from water, comprising: contacting the thin film composite membrane disclosed herein with an aqueous mixture comprising a divalent ion; and removing some or all of the divalent ion from the aqueous mixture via size-selective filtration.

In yet another aspect, disclosed is a method of removing an organic solute from water, comprising: contacting the thin film composite membrane disclosed herein with an aqueous solution comprising an organic solute; and separating the organic solute via size-selective filtration.

In yet another aspect, disclosed is a method of removing disease-causing microorganisms, comprising: contacting the thin film composite membrane disclosed herein with an mixture comprising one or more disease-causing microorganisms; and separating the one of more disease-causing microorganisms via reverse osmosis.

In yet another aspect, disclosed is a method of size-selective separation, comprising: contacting the thin film composite membrane disclosed herein with a mixture comprising one or more particles of differing sizes; and separating one or more particles via size-selective filtration.

In yet another aspect, disclosed is a method of processing food, comprising: contacting the thin film composite membrane disclosed herein with a impure food ingredient; and separating a contaminant from the impure food ingredient via size-selective filtration.

In yet another aspect, disclosed is a method of printing, comprising: contacting the thin film composite membrane disclosed herein with one or more ink; and applying the one or more ink to a surface of an article.

### EXAMPLES

In order that the invention described herein may be more fully understood, the following examples are set forth. The examples described in this application are offered to illustrate the compounds, compositions, materials, device, and methods provided herein and are not to be construed in any way as limiting their scope.

### Materials

Sulfobetaine methacrylate (SBMA, 95%), 2-Methacryloyloxyethyl phosphorylcholine (MPC, 97%), 2,2,2-Trifluoroethyl methacrylate (TFEMA), 2,2-Dimethoxy-2-phenylacetophenone (DMPA, 99%), N,N,N′,N″,N″-pentamethyldiethylenetriamine (PMDETA, 99%), 1,6-Hexanedithiol (≥97%, FG), α-α-ethyl bromoisobutyrate (EBIB, 98%), CuBr₂ (99%), Sodium sulphate, Acid blue 45, Brilliant blue R, Chicago sky blue 6B, Direct red 80, Methyl orange, Ethyl orange and activated aluminum oxide (basic, Brockmann I, standard grade) were purchased from Sigma-Aldrich. Allyl methacrylate (AMA, ≥98.0%), methanol (>99.8%), acetonitrile (≥99.5%), isopropyl alcohol (IPA, 99.5%), trifluoroethanol (TFE, ≥99.0%) sodium chloride (ACS certified), ethanol and riboflavin (98%), were purchased from Fisher scientific. Vitamin B12 was purchased from MP Biomedicals. Hexane was obtained from VWR. d4—Methanol (99.5%) and d6—DMSO (99.5%) was purchased from Cambridge Isotope Laboratories Inc. Ascorbic acid was purchased from GBiosciences. Commercial nanofiltration membrane NP-30 (permeance: 1.75 LMH/b) was obtained from Sterlitech. UE-50, the ultrafiltration support membrane was obtained from Sterlitech membranes. PS-35, the ultrafiltration support membrane, was obtained from Solecta membranes.

### Example 1. Synthesis of Poly (allyl methacrylate)-random-poly (sulfobetaine methacrylate) P(AM-r-SBMA)

In this example, a random copolymer with a poly (allyl methacrylate) (AM) backbone and zwitterion side-groups, used in the preparation of certain membranes of the invention, was synthesized as follows. Firstly, in a 2000 mL three neck round bottom flask 60 g AM and 40 g SBMA were mixed together in presence of 750 mL 1:1 acetonitrile:methanol. Afterwards, 1.55 mmol of α-ethyl bromoisobutyrate was added to the mixture and vigorously stirred under nitrogen environment. The ATRP reaction was initiated when a 1:1 acetonitrile:methanol solution (50 mL) containing CuBr₂ (0.0614 mmol), ascorbic acid (0.619 mmol) and N,N,N′,N″,N″-pentamethyldiethylenetriamine (0.619 mmol) was cannula transferred to the previously stirred solution of monomer and α-ethyl bromoisobutyrate. After addition of the catalyst solution to the monomer mixture the color of the reaction turned to light blue. The reaction was carried out for 20 hours at room temperature. After which, the reaction was stopped and rotary evaporator was used to concentrate the polymer solution. Finally, the remaining polymer mixture was precipitated into 5:3 v/v mixture of hexane:ethanol. The obtained polymer was re-dissolved in 1:1 acetonitrile:methanol and re-precipitated in hexane:ethanol mixture for three successive times. Finally, the obtained polymer was dried in ambient temperature under vacuum for three days. The obtained copolymer was characterized by ¹H NMR (FIG. 1D), and IR spectroscopy (FIG. 1E).

### Example 2. Formation of Thin Film Composite Membranes from P(AM-r-SBMA)

In this example, a membrane was prepared using the polymer described in Example 1. The P(AM-r-SBMA) copolymer was first dissolved in TFE (5 wt %) at room temperature and passed successively through both 1 μm and 0.45 μm filter. The obtained final polymer solution was degassed overnight in a sealed vial prior to the coating of the selective layer. Afterwards, a commercial ultrafiltration support membrane (PS 35 from Solecta) was taped on top of the glass plate. Finally, with the copolymer solution, the selective layer was coated on top of the support membrane using a wire-wound metering rod (Gardco). Immediately after coating, the glass plate was rotated by 180° and taken to a pre-heated oven (65° C.) for 12 minutes. Later, the dry TFC membrane was immediately immersed in DI water for overnight.

### Example 3. Synthesis of Thiol-Ene Crosslinked Thin Film Composite Membranes

In this example, the membrane in Example 2 with the selective layer of random copolymer PAM-r-SBMA was crosslinked as follows. Crosslinking of the pristine membrane (TCZ-0) was done through UV assisted Thiol-ene click chemistry. TCZ-0 membrane coated with P(AM-r-SBMA) copolymer was first soaked in a solution of isopropanol (20 mL) containing 1 wt % each of 1,6-Hexanedithiol and 2,2-Dimethoxy-2-phenylacetophenone for 10 minutes. The soaking was done to saturate the hydrophobic domain with photoinitiator and thiol. Then, most of the solution (90%) was taken out from the glass container and the membrane with remaining solution was subjected to immediate UV (365 nm, 9 W/bulb, four bulbs) curing for different time scales ranging between 10 seconds to 40 seconds. After UV curing, the membrane was taken out from the glass container and cleaned extensively with isopropanol and DI water. Finally, cleaned membranes were kept in DI water prior to any experiments.

Film morphology was determined by SEM imaging of freeze-fractured cross-sections of the membranes.

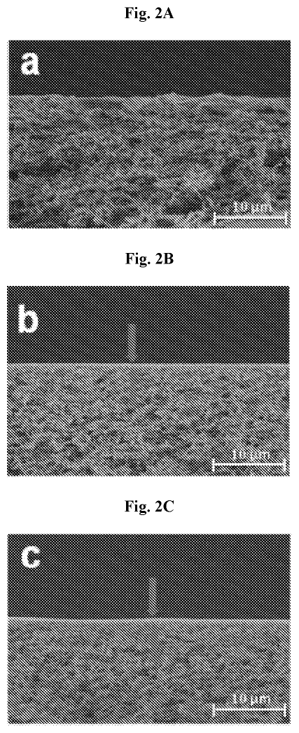

In FIGS. 2A-2C, SEM images of three different samples of membranes are shown. The coating layer can be observed for FIGS. 2B and 2C. FIG. 2A represents uncoated PS-35 support membrane, FIG. 2B represents uncrosslinked (TCZ-0) membrane with the random zwitterionic support layer, and FIG. 2C shows Crosslinked (TCZ-40) membrane. TCZ-40 membrane was kept in TFE for 24 hours prior taking the SEM. Presence of selective layer on TCZ-40 membrane even after soaked in TFE solvent signifies that membrane was successfully crosslinked. (FIGS. 2A-2C) 7000× magnification.

### Example 4. Synthesis of Poly (allyl methacrylate)-random-Poly (trifluoro ethyl methacrylate)-random-poly (2-methacryloyloxyethyl phosphorylcholine) [P(AMA-r-TFEMA-r-MPC) terpolymer]

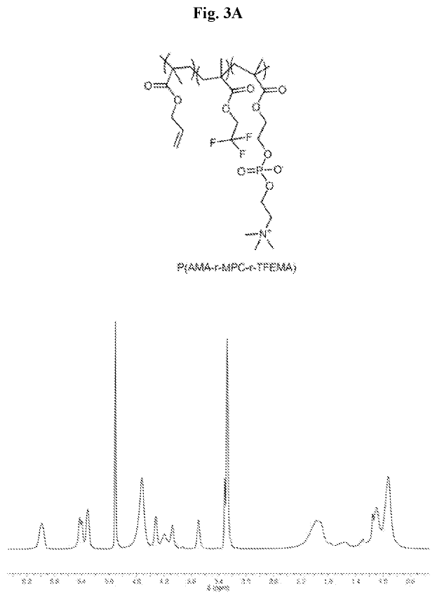

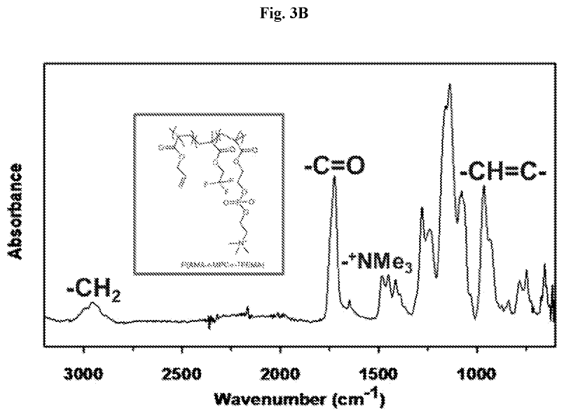

First allyl methacrylate (AMA) and trifluoro ethyl methacrylate (TFEMA) monomers were purified through basic alumina column and kept under nitrogen for further use. 11.81 g 2-methacryloyloxyethyl phosphorylcholine (MPC) was dissolved in 260 mL methanol in a 1000 mL three neck round bottom flask. Next, 11 g AMA and 11.1 g TFEMA were added and mixed thoroughly. To remove dissolved oxygen from the mixture, the solution was purged continuously with nitrogen. α-ethyl bromoisobutyrate (0.48 mmol) initiator was added to the reaction mixture and vigorously stirred under a nitrogen environment. A catalyst solution was prepared in a separate container by dissolving CuBr₂, ascorbic acid and N,N,N′,N″,N″-pentamethyldiethylenetriamine in methanol under nitrogen purge. The mole ratio between Monomer:initiator:catalyst:ligand:reducing agent was chosen as 402:1:0.0391:0.396:0.398. The reaction was initiated when this catalyst solution was transferred to the previously stirred solution of monomer and α-ethyl bromoisobutyrate using a cannula. The reaction mixture turned light blue after the addition of the catalyst solution to the monomer and initiator mixture. The reaction was carried out for 20 hours at room temperature, after which the reaction was stopped by exposing the reaction mixture to air. A rotary evaporator was used to concentrate the polymer solution. The polymer was then precipitated in a 3:2 v/v mixture of isopropanol:hexane. The obtained polymer was re-dissolved in methanol and re-precipitated in the isopropanol:hexane mixture for three successive times. Finally, the obtained polymer was dried in ambient temperature under vacuum for three days. The obtained copolymer was characterized by ¹H NMR (FIG. 3A), and IR (FIG. 3B) spectroscopy.

### Example 5. Formation of Thin Film Composite Membranes from P(AM-r-TFEMA-r-MPC)

The P(AMA-r-TFEMA-r-MPC) terpolymer from Example 4 was first dissolved in methanol (4 wt %) at room temperature and passed successively through 1.2 μm Titan 3, HPLC filters, GMF membrane and 0.45 μm PTFE, ThermoScientific. Prior to the coating of the selective layer the obtained polymer solution was degassed overnight in a sealed vial. On top of a clean glass plate the commercial ultrafiltration support membrane (UE 50 from Sterlitech) was taped. Later, the degassed polymer solution was carefully coated onto the support membrane using a wire-wound metering rod (Gardco, #8, wet film thickness 20 μm). Once the coating was done, the glass plate was placed in a pre-heated oven (80° C.) for 4 minutes. Later, the dry TFC membrane was immediately immersed in DI water for overnight.

### Example 6. Synthesis of Thiol-Ene Crosslinked Thin Film Composite Membranes

UV-assisted thiol-ene click chemistry was employed to perform the crosslinking of the membrane described in Example 5. The membrane from Example 5 uniformly coated with P(AMA-r-TFEMA-r-MPC) terpolymer was first soaked in a solution of 1:1 isopropanol:hexane (20 mL) containing 2 wt % each of 1,6-Hexanedithiol and 2,2-Dimethoxy-2-phenylacetophenone for 20 minutes. The soaking was performed to saturate the hydrophobic domain with photoinitiator and thiol. Then, most of the solution (˜90%) was taken out from the glass container and the membrane with remaining solution was subjected to immediate UV curing (365 nm, 9 W/bulb, and four bulbs) for different time scales ranging between 300 seconds to 14 minutes. After UV curing, the membrane was taken out from the glass container and cleaned extensively with isopropanol:hexane mixture followed by DI water. Finally, cleaned membranes were kept in DI water prior to any experiments.

### Membrane Characterization

Membrane was characterized using attenuated total reflectance Fourier transform infrared (ATR-FTIR) spectroscopy, scanning electron microscopy (SEM), transmission electron microscopy (TEM), and X-ray photoelectron spectroscopy (XPS). Membrane morphology was characterized using Phenom G2 Pure Tabletop Scanning Electron Microscope (SEM) operating at 5 kV. Liquid nitrogen was used to freeze-fracture the samples for cross-sectional images. Before imaging, samples were sputter coated with gold-palladium.

### Self-Assembled Nanostructure of Copolymers

Transmission electron microscopy (TEM) was used to characterize the self-assembled nanostructure morphology of the random copolymers. TEM images were obtained by FEI Technai Spirit in bright field mode operated at 80 keV. 8% (w/v) copolymer solution was made in trifluoroethanol (TFE) solution. Films were cast from this solution by evaporating in Teflon dishes. 2% aqueous copper (II) chloride (CuCl₂) solution was used for the positive staining of the zwitterionic domains for 4 h. The reason for choosing CuCl2 was the formation of stable the complex between sulfobetaine and copper. Stained films were embedded in Embed 812 epoxy resin for two nights with frequent epoxy replacement, and ultrathin 50 nm sections cut using an ultramicrotome were placed on copper grids (200 mesh, Electron Microscopy Sciences). Nicki Watson from Harvard CNS center was responsible for acquiring TEM images. Fast Fourier Transform analysis was performed on the TEM images using ImageJ software.

### Molecular Weight of Copolymers

Dynamic Light Scattering (DLS) was performed using a Brookhaven Instruments Nanobrook ZetaPALS instrument to estimate the approximate molecular weight of the synthesized copolymers. The light source was a 35 mW red diode laser with a nominal wavelength of 659 nm. First, the copolymer was dissolved in TFE with a concentration of 1 mg/ml. DLS measurements were performed at a scattering angle of 90° and a temperature of 25° C., which was controlled by means of a thermostat. A 0.45 mm filter was used to remove dust before light scattering experiments. Measurements were taken once the sample solution stabilized. A polyacrylonitrile standard in dimethyl formamide (DMF) was used for the calculation of the effective hydrodynamic radius and relative molecular weight by the instrument software (BIC Particle Solutions v. 2.5).

### XPS of Different Membranes

To assess the surface elemental compositions of different membranes, X-ray photoelectron spectroscopy (XPS) was performed with a spectrometer using a monochromated Al Kα source. For survey spectra, the scan was completed by taking an average of 5 scans in 1 eV steps with passing energy at 200 eV from 10 eV to 1350 eV binding energy. For high resolution spectra, the data were collected by taking an average of 10 scans in 0.1 eV steps with passing energy at 50 eV for S2p, N 1s, O 1s, and C 1s photoelectron lines.

### FTIR Characterization of Copolymers and Membranes

The Fourier Transform Infrared (FTIR) spectra of the random zwitterionic copolymer copolymers and corresponding membrane was recorded with the attenuated total reflectance (ATR) technique by a FTIR spectrometer with a resolution of 2 cm⁻¹ and a wide spectral range of 400-4000 cm⁻¹.

### NMR Characterization of Copolymer

The synthesized random zwitterionic copolymer was characterized by ¹H NMR spectroscopy with an AV III 500 NMR spectrometer (500 MHz; Bruker, USA) using d-DMSO (with tetramethylsilane as an internal reference) as the solvent.

### Permeance Measurements and Single Solute Filtration

Membrane filtration experiments were carried out using 25 mm diameter membranes in a 10 ml Amicon 8010 stirred, dead-end filtration cell (Millipore) with an effective filtration area of 4.1 cm2, attached to a reservoir of 1 gal capacity. The permeate mass was monitored using an electronic balance (Scout Pro) attached to a computer. 43.5 psi (3 bar) transmembrane pressure was utilized for all filtration experiments. During filtration, Amicon cells were continuously stirred using a stir plate to minimize concentration polarization. DI water was first filtered through the membrane until the flux remained stable. Afterwards, permeate mass was recorded at 30 sec intervals for a desired time period, which was used to determine the transmembrane flux. Flux is defined as the flow rate through the membrane normalized by membrane area. Permeance is a membrane property that normalizes the flux to account for the applied transmembrane pressure difference, and is obtained by the following equation:

$$\\ {L}_{p} = J / Δ P = \frac{m}{ρ A Δ P}$$

Where Lp is the permeance of the membrane (L m−2 h−1 bar−1), J is the water flux across the membrane (L m−2 h−1), ΔP is the transmembrane pressure (bar). m^{⋅} is known as the mass flowrate, ρ is the permeate density (assumed 1.0 g/mL), A is the membrane area. In order to determine the rejection of different dyes and salts, 10 mL of feed solution was used and then filtered more than 2 mL, finally collected the permeate for further analysis. For dye concentration measurements, a UV-vis spectrometer (Genesys10) was used. For determination of salt concentration, a conductivity meter (high range, VWR) was used. The relationship between salt concentration and conductivity was determined by first preparing a calibration curve using the stock feed solutions. Rejection was calculated via the following equation:

$$\\ R = 100 \% ( 1 - \frac{{C}_{Permeate}}{{C}_{Feed}} )$$

Where CPermeate is the permeate concentration and CFeed is the feed concentration.

### Fouling Experiments

Fouling experiments were conducted using the same equipment as permeance, but the trans-membrane pressure was adjusted so that all membranes had an initial water flux of 2.75 L/m2·h·bar to achieve similar hydrodynamic conditions at the membrane surface. Experiments were conducted using three foulant solutions: (1) 1500 mg/L oil-in-water emulsion (9:1 ratio of soybean oil:DC193 surfactant), (2) 1 g/L of bovine serum albumin in PBS buffer (pH 7.4), and (3) 1 g/L of bovine serum albumin in 10 mM CaCl2. In each fouling experiment, first, DI water was filtered through the membrane for six hours to determine the pure water flux (J0). Then, the cell and reservoir were filled with the foulant solution. After filtering the foulant solution for the desired time period, the resultant flux (J) over time was calculated. The cell and reservoir were rinsed several times with DI water for cleaning and refilled with DI water to determine the reversibility of fouling (final permeance).

### Acid and Base Stability Tests

The TCZ-20 membrane was first carefully dipped in 0.5 M NaOH for 24 hours. Afterwards, the membrane was washed carefully with DI water so that trace amounts of base can be removed from membrane surface. Finally after base treatment, pure water permeance and B12 rejection was tested and compared with the data before base treatment. It was observed that no significant changes can be seen after base treatment, which provides adequate idea about the base stability of prepared membranes. Also for acid stability the same protocol was followed and the only exception was instead of using 0.5 NaOH, 0.5 M HCl solution was used. In this case also no significant changes can be seen in pure water permeance or B12 rejection after acid stability test.

### Membrane Testing

For membranes with P(AM-r-SBMA) copolymer: Membrane filtration experiments were conducted on 4.1 cm2 membrane disks using a 10 mL Amicon 8010 stirred, dead-end filtration cell (Millipore), attached to a 1 gal reservoir. The weight of the permeate was monitored through an electronic scale (Ohaus Scout Pro) connected to a computer. Membrane permeance (Lp) was determined by Lp=J/ΔP, where J is the volumetric flux of permeate and ΔP is the applied trans-membrane pressure. For rejection measurements (both salts and dye), 10 mL of feed solution was loaded, filtered and discarded ≈2 mL of permeate, and then collected an additional permeate fraction for analysis. This was found to result in reliable and steady rejection values. Rejection (R) was determined by R=(1−CP/CF)100%, where CF and CP are the feed and permeate concentrations, respectively. For the fouling studies, we first determined initial flux, fouled the membranes for 18-20 h, and finally rinsed the membrane gently with water before measuring the final flux.

For membranes with P(AMA-r-TFEMA-r-MPC) terpolymer: Membrane filtration experiments were conducted using dead-end stirred cell filtration, using protocols described above. To estimate the rejection of both salts and dyes, the cell was loaded with 10 mL of feed solution, discarded the first ˜1.5-2 mL of permeate and then collected the following fraction for analysis, previously shown to be representative of steady-state rejection (Bengani-Lutz, et at., High Flux Membranes with Ultrathin Zwitterionic Copolymer Selective Layers with ˜1 nm Pores Using an Ionic Liquid Cosolvent. ACS Applied Polymer Materials 1, 1954-1959, (2019)). For the fouling studies, first, deionized water was filtered through the membrane until a constant permeance was reached. Then, the foulant solution was filtered for 18-20 hours and the permeance was monitored. Finally, the cell and the membrane was rinsed gently with deionized water, and the final pure water flux was measured.

### Example 7. Dye Rejection by Crosslinked P(AM-r-SBMA) Membranes

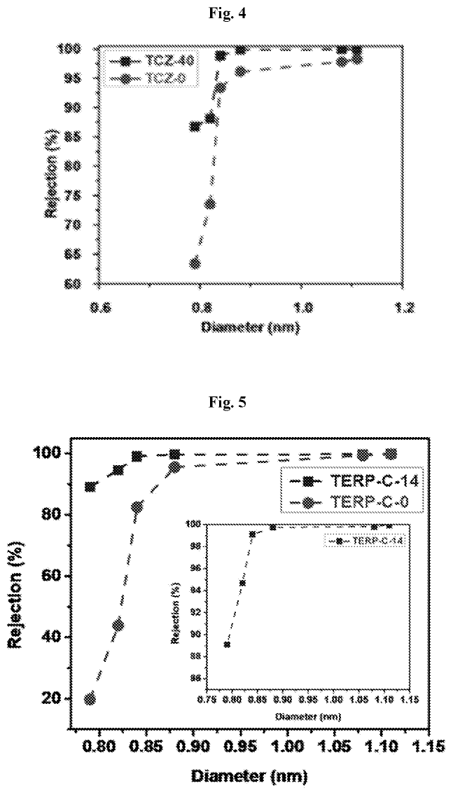

In this example, membranes prepared as described in Example 3 were used in experiments aimed at identifying their effective pore size, or size cut-off. Dye molecules were used to probe this property, because dye molecules are rigid, and their concentrations are easily measured by UV-Vis spectroscopy. The retention experiments were performed on an Amicon 8010 stirred, dead-end filtration cell (Millipore) with a cell volume of 10 mL and an effective filtration area of 4.1 cm². The test was performed at 43.5 psi. The cell was stirred to minimize concentration polarization effects, after running pure water through the membrane for at least an hour, the cell was emptied, and a 100 mg/L solution of the probe dye in water was placed in the cell. After an equilibration period of at least an hour, a sample was collected until enough was obtained for analysis by UV-Visible spectrophotometry. The cell was rinsed several times with water. Pure water was filtered through the membrane until the permeate was completely clear before switching to a new probe dye. FIG. 4 shows the retention of various negatively charged dyes by the membranes made from the copolymers mentioned in examples 1. Based on the filtration of these anionic dyes, the size cut-off of the membranes is estimated to be between 1-1.2 nm. Furthermore, the rejection of these dyes is related directly with the molecular size of the dye rather than its charge. Thus, such membranes may be used for size-selective separations. FIG. 4 shows rejection of anionic dyes of different molecular diameters. Table 1 shows molecular size and charge of dyes used in testing the effective pore size, and their rejection by the membrane described in Example 3.

TABLE 1
Rejection of anionic dyes of different diameters

| Solute Name | Calculated diameter [nm] | Charge | λ[nm] |
|---|---|---|---|
| Brilliant blue R | 1.11 | −1 | 553 |
| Direct red 80 | 1.08 | −6 | 528 |
| Chicago sky blue 6B | 0.88 | −4 | 593 |
| Acid blue 45 | 0.84 | −2 | 595 |
| Ethyl orange | 0.82 | −1 | 474 |
| Methyl orange | 0.79 | −1 | 463 |

### Example 8. Dye Rejection by Crosslinked P(AM-r-TFEMA-r-MPC) Membranes

In this example, membranes prepared as described in Examples 6 were used in experiments aimed at identifying their effective pore size, or size cut-off. The dye molecules were used to probe this property, because dye molecules are rigid, and their concentrations are easily measured by UV-Vis spectroscopy. The retention experiments were performed on an Amicon 8010 stirred, dead-end filtration cell (Millipore) with a cell volume of 10 mL and an effective filtration area of 4.1 cm². The test was performed at 43.5 psi. The cell was stirred to minimize concentration polarization effects, After running pure water through the membrane for at least an hour, the cell was emptied, and a 100 mg/L solution of the probe dye in water was placed in the cell. After an equilibration period of at least an hour, a sample was collected until enough was obtained for analysis by UV-Visible spectrophotometry. The cell was rinsed several times with water. Pure water was filtered through the membrane until the permeate was completely clear before switching to a new probe dye. FIG. 5 shows the retention of various negatively charged dyes by the membranes made from the copolymers mentioned in examples 4. Based on the filtration of these anionic dyes, the size cut-off of the membranes is estimated to be between 1-1.2 nm. Furthermore, the rejection of these dyes is related directly with the molecular size of the dye rather than its charge. Thus, such membranes may be used for size-selective separations. FIG. 5 shows rejection of anionic dyes of different molecular diameters.

### Example 9. Small Molecule Separation by Crosslinked P(AM-r-SBMA) Membranes

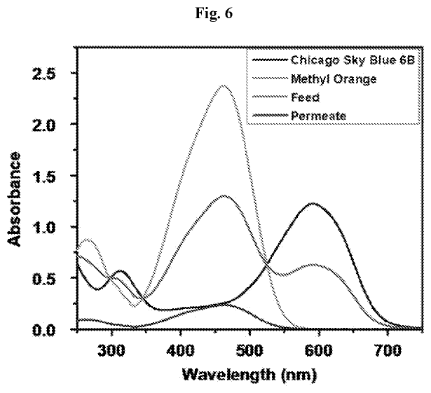

In this example, membranes prepared as described in examples 3 was used in experiments to determine their small molecule separation capability. To estimate the membrane's capability for small molecule separation, a mixed solution of 0.05 mM of each anionic dyes, Chicago Sky Blue 6B (0.88 nm) and methyl orange (0.79 nm) was filtered through TCZ-40 membrane. FIG. 6 shows the UV spectra for both the dyes, feed, as well as permeate. It is evident from the figure that the permeate spectra contains no Chicago Sky Blue 6B peaks (at 597 nm), indicating that the dye was completely retained and separated by the membrane. However, methyl orange peak can still be observed suggesting the suitable size based separation efficiency of the membrane. FIG. 6 shows size-based small molecule separation capability of TCZ-40 membrane was monitored when two different dyes (0.05 mM each) Chicago sky blue 6B (0.88 nm) and methyl orange (0.79 nm) were mixed together as a feed for a diafiltration experiment. Image shows the UV spectra of the feed, permeate, and each single dye for reference. Only methyl orange permeates through the TCZ-40 membrane, while Chicago sky blue 6B was completely retained.

### Example 10. Small Molecule Separation by Crosslinked P(AM-r-TFEMA-r-MPC) Membranes

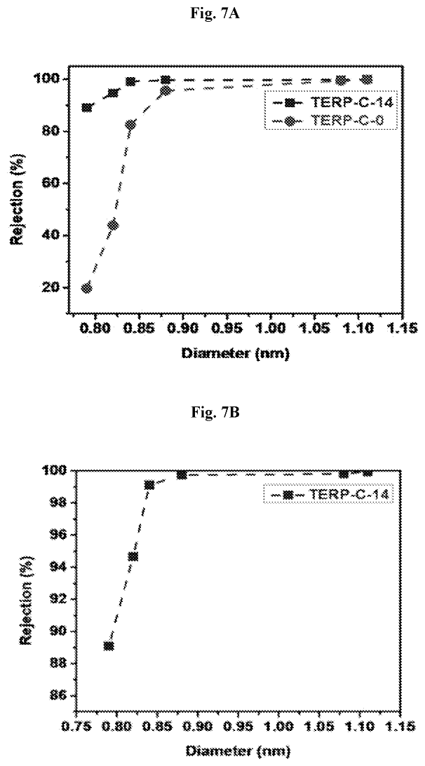

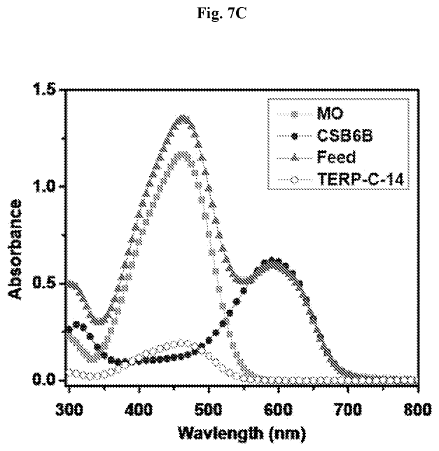

In this example, membranes prepared as described in Examples 6 was used in experiments to determine their small molecule separation capability. To estimate the membrane capability for small molecule separation, a mixed solution of 0.05 mM of each anionic dyes, Chicago Sky Blue 6B (0.88 nm) and methyl orange (0.79 nm) was filtered through TCZ-40 membrane. FIG. 6 shows the UV spectra for both the dyes, feed, as well as permeate. It is evident from the figure that the permeate spectra contains no Chicago Sky Blue 6B peaks (at 597 nm), indicating that the dye was completely retained and separated by the membrane. However, methyl orange peak can still be observed suggesting the suitable size based separation efficiency of the membrane. FIG. 7C shows size-based small molecule separation capability of TERP-C-14 membrane was monitored when two different dyes (0.05 mM each) Chicago sky blue 6B (0.88 nm) and methyl orange (0.79 nm) were mixed together as a feed for a diafiltration experiment. Image shows the UV spectra of the feed, permeate, and each single dye for reference. Only methyl orange permeates through the TERP-C-14 membrane, while Chicago sky blue 6B was completely retained. FIG. 7A shows the rejection of anionic dyes of varying sizes by TERP-C-0 (uncrosslinked) and TERP-C-14 (crosslinked) membranes. Both membranes showed a sharp size cut-off. Crosslinked membrane showed higher rejections than the non-crosslinked one, confirming that crosslinking leads to smaller effective pore size. FIG. 7B shown only the rejection performance of TERP-C-14.

### Example 11. Salt Rejection by Crosslinked P(AM-r-SBMA) Membranes

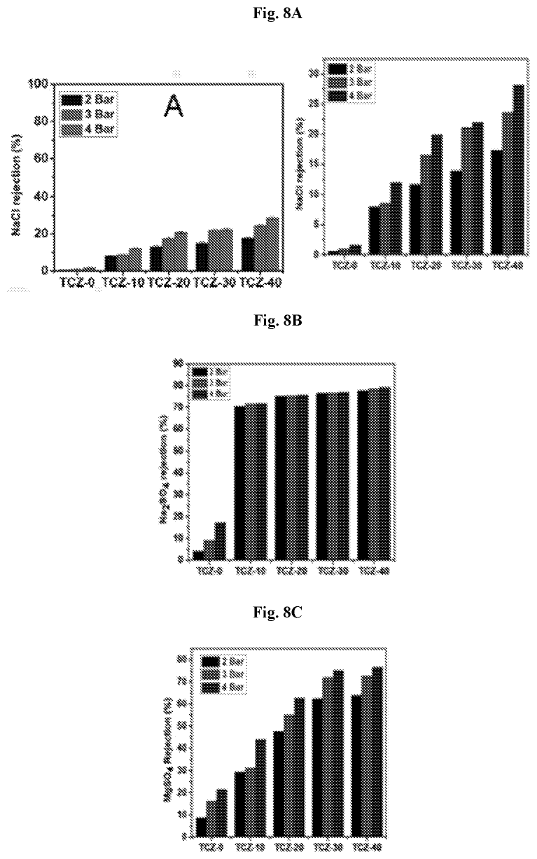

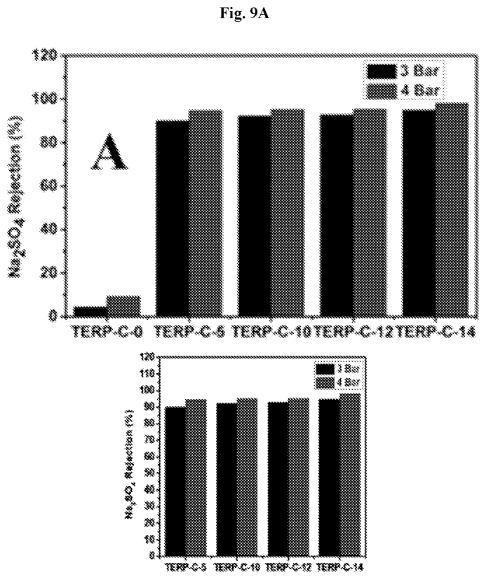

In this example, membranes prepared as described in Example 3 was used in experiments to determine their salt retention properties. The retention experiments were performed on an Amicon 8010 stirred, dead-end filtration cell (Millipore) with a cell volume of 10 mL and an effective filtration area of 4.1 cm². The cell was stirred at 450 rpm, and the test was performed at different pressure e.g. 2, 3, 4 bar respectively. The cell was stirred to minimize concentration polarization effects. After running pure water through the membrane for at least an hour, the cell was emptied, and a 20 mM solution of sodium chloride (NaCl), sodium sulfate (Na₂SO₄) and magnesium sulfate (MgSO₄, Aldrich) in water was separately placed in the cell. After an equilibration period of at least an hour, a sample was collected for analysis by a standard conductivity probe. The cell was rinsed several times with water, and pure water was run through the membrane before switching to other feed solutions. FIGS. 8A-8C show rejection performance of 20 mM NaCl (FIG. 8A), Na₂SO₄ (FIG. 8B) and MgSO₄ (FIG. 8C) salts at various applied pressure for un-crosslinked TCZ-0 and Crosslinked TCZ membranes.

### Example 12. Salt Rejection by Crosslinked P(AM-r-TFEMA-r-MPC) Membranes

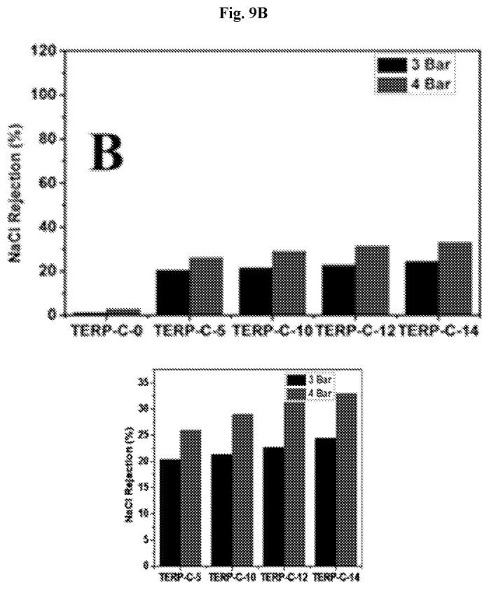

In this example, membranes prepared as described in Example 6 was used in experiments to determine their salt retention properties. The retention experiments were performed on an Amicon 8010 stirred, dead-end filtration cell (Millipore) with a cell volume of 10 mL and an effective filtration area of 4.1 cm². The cell was stirred at 450 rpm, and the test was performed at different pressure e.g. 3, 4 bar respectively. The cell was stirred to minimize concentration polarization effects. After running pure water through the membrane for at least an hour, the cell was emptied, and a 20 mM solution of sodium chloride (NaCl), and sodium sulfate (Na₂SO₄) in water was separately placed in the cell. After an equilibration period of at least an hour, a sample was collected for analysis by a standard conductivity probe. The cell was rinsed several times with water, and pure water was run through the membrane before switching to other feed solutions. FIGS. 9A and 9B show rejection performance of 20 mM Na₂SO₄ ((left) and NaCl (right) salts at various applied pressure for Crosslinked TERP-C-X (X=5, 10, 12, 14) membranes.

### Example 13. Fouling Test by Crosslinked P(AM-r-SBMA) Membranes with Oil-Water Emulsion

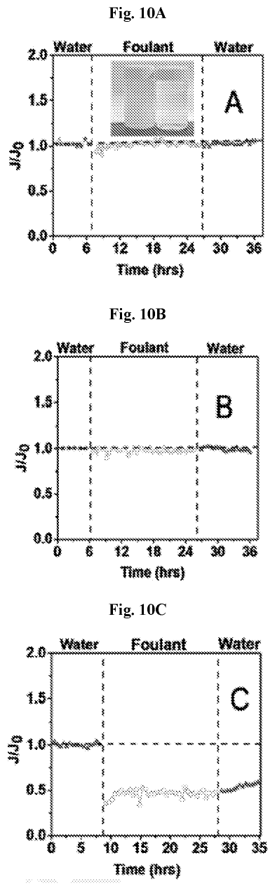

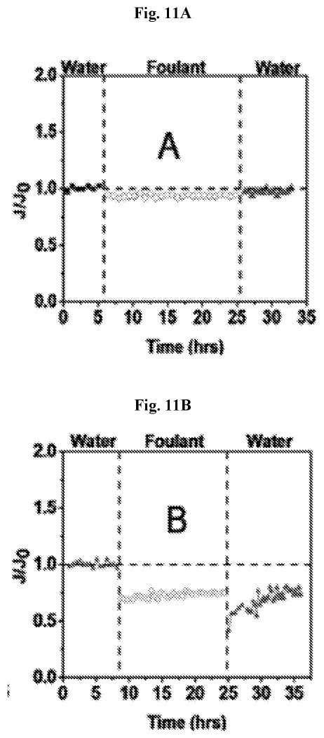

In this example, membranes prepared as described in Example 3 was used in experiments to determine their antifouling properties. The retention experiments were performed on an Amicon 8010 stirred, dead-end filtration cell (Millipore) with a cell volume of 10 mL and an effective filtration area of 4.1 cm². The cell was stirred and the test was performed at a flux of 2.75 L m⁻² hr⁻¹. Pure water permeance was measured for the membrane for at least six hour, then the cell was emptied, and a foulant solution composed of 1500 mg/L oil-in-water (9:1) emulsion was filtered for 20 hours. Finally again pure water permeance was re measured. FIGS. 10A-10C shows dead-end-filtration of foulant solutions through TCZ-30 (FIG. 10A), TCZ-40 (Fing. 10B), and a commercial membrane NP-30 (FIG. 10C). Images showed the initial water permeance (triangle and square), followed by the permeance of the foulant solution (circle). Then, the membrane is rinsed with water several times, and water permeance is measured again (triangle and square). In case of, TCZ-30 and TCZ-40 membranes no flux loss was observed during and after exposure to foulant solutions, whereas the commercial membrane shows significant (˜48%) irreversible flux loss. The foulant solution was composed of 1500 mg/L oil-in-water (9:1) emulsion. J₀=2.75 L m⁻² hr⁻¹.

### Example 14. Fouling Test by Crosslinked P(AM-r-SBMA) Membranes with BSA/CaCl₂ Solution

In this example, membranes prepared as described in examples 3 was used in experiments to determine their antifouling properties by filtering BSA protein. The retention experiments were performed on an Amicon 8010 stirred, dead-end filtration cell (Millipore) with a cell volume of 10 mL and an effective filtration area of 4.1 cm². The cell was stirred, and the test was performed at a flux of 2.75 L m⁻² hr⁻¹. First pure water permeance was checked through the membrane for at least five hours, the cell was emptied, and a foulant solution composed of 1 g/L Bovine Serum Albumin in 10 mM CaCl₂ solution was placed in the cell. The protein filtration was run for 18 hours and then again pure water permeance was checked. Before pure water permeance the cell was rinsed several times with water. FIGS. 11A-11B shows dead-end-filtration of foulant solutions through TCZ-40 (FIG. 11A), and a commercial membrane NP-30 (FIG. 11B). In case of, TCZ-40 membranes negligible flux loss was observed during and after exposure to foulant solutions, whereas the commercial membrane shows significant (˜27%) irreversible flux loss. The foulant solution was composed of 1 g/L Bovine Serum Albumin in 10 mM CaCl₂ solution. J₀=2.75 L m⁻² hr⁻¹.

### Example 15. Fouling Test by Crosslinked P(AM-r-TFEMA-r-MPC) Membranes with Oil-Water Emulsion

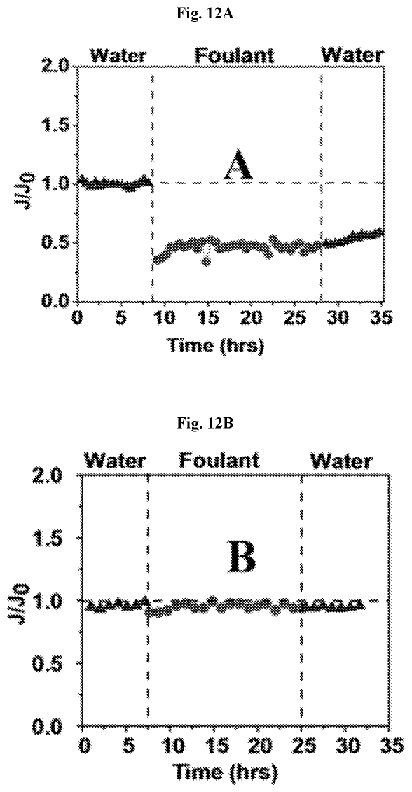

In this example, membranes prepared as described in Examples 6 was used in experiments to determine their antifouling properties. The retention experiments were performed on an Amicon 8010 stirred, dead-end filtration cell (Millipore) with a cell volume of 10 mL and an effective filtration area of 4.1 cm². The cell was stirred and the test was performed at a flux of 2.75 L m⁻² hr⁻¹. Pure water permeance was measured for the membrane for at least six hour, then the cell was emptied, and a foulant solution composed of 1500 mg/L oil-in-water (9:1) emulsion was filtered for 18 hours. Finally again pure water permeance was re measured. FIGS. 12A and 12B show dead-end-filtration of foulant solutions through a commercial membrane NP-30 (FIG. 12A), and TERP-C-14 (FIG. 12B). Images showed the initial water permeance (black), followed by the permeance of the foulant solution (red). Then, the membrane is rinsed with water several times, and water permeance is measured again (blue). In case of, TERP-C-14 and membrane no flux loss was observed during and after exposure to foulant solutions, whereas the commercial membrane shows significant (˜48%) irreversible flux loss. The foulant solution was composed of 1500 mg/L oil-in-water (9:1) emulsion. J₀=2.75 L m⁻² hr⁻¹.

### Example 16. Fouling Test by Crosslinked P(AM-r-TFEMA-r-MPC) Membranes with BSA/CaCl₂ Solution

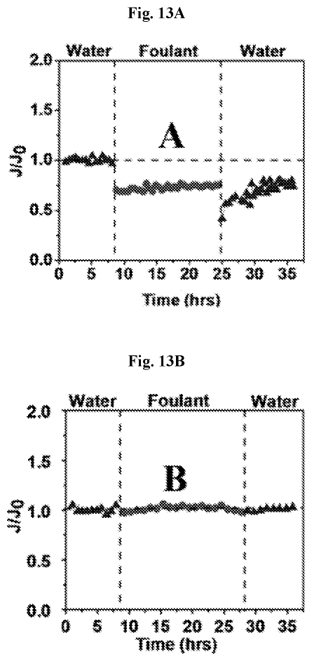

In this example, membranes prepared as described in examples 6 was used in experiments to determine their antifouling properties by filtering BSA protein. The retention experiments were performed on an Amicon 8010 stirred, dead-end filtration cell (Millipore) with a cell volume of 10 mL and an effective filtration area of 4.1 cm². The cell was stirred, and the test was performed at a flux of 2.75 L m⁻² hr⁻¹. First pure water permeance was checked through the membrane for at least five hours, the cell was emptied, and a foulant solution composed of 1 g/L Bovine Serum Albumin in 10 mM CaCl₂ solution was placed in the cell. The protein filtration was run for 20 hours and then again pure water permeance was checked. Before pure water permeance the cell was rinsed several times with water. FIGS. 13A and 13B show dead-end-filtration of foulant solutions through the membrane TERP-C-14 (FIG. 13B) along with a commercial membrane NP-30 (FIG. 13A). In case of, TERP-C-14 membranes no flux loss was observed during and after exposure to foulant solutions, whereas the commercial membrane shows significant (˜27%) irreversible flux loss. The foulant solution was composed of 1 g/L Bovine Serum Albumin in 10 mM CaCl₂ solution. J₀=2.75 L m⁻² hr⁻¹.

### Example 17. Non-Aqueous Crosslinking of P(AM-r-TFEMA-r-MPC)

Crosslinking Technique: Soak the membrane in a solution of 2 wt % of photoinitiator and crosslinker (see FIG. 16) in 1:1 isopropanol:hexane mixture (20 mL) for 20 minutes and then UV cured for 30 seconds while the membrane was inside glass container and the face was covered with a glass plate.

| | Before Crosslinking | After Crosslinking |
|---|---|---|
| Permeance | ~7.7 L/m²/h/bar | ~4.3 L/m²/h/bar |
| Rejection of VB12 | ~82% | ~97.01% |
| Rejection of Riboflavin | ~25.4% | ~38.1% |

### Example 18. Non-Aqueous Crosslinking of P(AM-r-TFEMA-r-MPC)

Crosslinking Technique: Soak the membrane in a solution of 2 wt % of photoinitiator and crosslinker (see FIG. 16) in 1:1 isopropanol:hexane mixture (20 mL) for 20 minutes and then UV cured for 60 seconds while the membrane was inside glass container and the face was covered with a glass plate.

| | Before Crosslinking | After Crosslinking |
|---|---|---|
| Permeance | ~7.83 L/m²/h/bar | ~1.42 L/m²/h/bar |
| Rejection of VB12 | ~81.2% | ~98.24% |
| Rejection of Riboflavin | ~22.91% | ~57% |

### Example 19. Non-Aqueous Crosslinking of P(AM-r-TFEMA-r-MPC)

Crosslinking Technique: Soak the membrane in a solution of 2 wt % of photoinitiator and crosslinker (see FIG. 16) in 1:1 isopropanol:hexane mixture (20 mL) for 20 minutes and then UV cured for 90 seconds while the membrane was inside glass container and the face was covered with a glass plate.

| | Before Crosslinking | After Crosslinking |
|---|---|---|
| Permeance | ~7.98 L/m²/h/bar | ~1.14 L/m²/h/bar |
| Rejection of VB12 | ~79.1% | ~98.34% |
| Rejection of Riboflavin | ~28.3% | ~58.1% |

### Example 20. Non-Aqueous Crosslinking of P(AM-r-TFEMA-r-MPC)

Crosslinking Technique: Soak the membrane in a solution of 2 wt % of photoinitiator and crosslinker (see FIG. 16) in 1:1 isopropanol:hexane mixture (20 mL) for 20 minutes and then UV cured for 120 seconds while the membrane was inside glass container and the face was covered with a glass plate.

| | Before Crosslinking | After Crosslinking |
|---|---|---|
| Permeance | ~7.43 L/m²/h/bar | ~0.56 L/m²/h/bar |
| Rejection of VB12 | ~79% | ~99.88% |
| Rejection of Riboflavin | ~24.6% | ~67% |

### Membrane Synthesis and Cross-Linking (P(AM-r-TFEMA-r-MPC))

The statistical/random copolymer represented here is a combination of three different monomers: 2-methacryloyloxyethyl phosphorylcholine (MPC), a zwitterionic monomer; trifluoroethyl methacrylate (TFEMA), a highly hydrophobic monomer; and allyl methacrylate (AM), a hydrophobic monomer that has a C—C double bond that can readily can undergo thiol-ene click reactions (FIG. 1B). The double bonds present in the AMA units can be crosslinked through a thiol-ene click reaction in presence of a dithiol (FIG. 1B). This cross-linking reaction is performed in a solvent that preferentially partitions into the hydrophobic domains, but not the zwitterionic domains. The solvent also plasticizes the TFEMA/AMA domains, increasing the mobility of functional groups sufficiently to enable cross-linking reactions. The cross-linked hydrophobic domains are more rigid, and restrict the swelling of zwitterionic domains when immersed in water. Hence, it leads to smaller effective pore sizes in the cross-linked ZAC-based membrane than un-crosslinked copolymer selective layers in water.

P(AMA-r-TFEMA-r-MPC) terpolymer was successfully synthesized by the activator regenerated by electron transfer atom transfer radical polymerization (ARGET-ATRP) (FIG. 1B). This is controlled polymerization reaction almost exclusively polymerizes the more reactive methacrylate groups, leaving most of the low reactivity allyl side-groups intact. The presence of the allylic double bond (δ=5.3 ppm; δ=5.8 ppm) in the terpolymer was confirmed through ¹H NMR (FIG. 3A) and IR (FIG. 3B) analysis of P(AMA-r-TFEMA-r-MPC). The prepared copolymer is a white solid, and soluble in trifluoroethanol (TFE), and methanol.

P(AMA-r-TFEMA-r-MPC) was coated onto a commercial support membrane (Sterlitech, UE50) to form a TFC membrane. To achieve this, P(AMA-r-TFEMA-r-MPC) was dissolved in methanol to form a 4 wt % solution, which was then coated on top of the support membrane by using a wire-wound metering rod. This coated membrane was placed in an oven preheated to 80° C. for 4 minutes. Finally, the membrane was taken out of the oven and immersed in distilled water overnight. This thin film composite (TFC) membrane, as fabricated and without any cross-linking, is termed TERP-C-0. Random copolymers of TFEMA and MPC microphase separate to form a network of ˜1.3 nm disordered bicontinuous domains (Bengani-Lutz, et al., Self-Assembling Zwitterionic Copolymers as Membrane Selective Layers with Excellent Fouling Resistance: Effect of Zwitterion Chemistry. ACS Applied Materials & Interfaces 9, 20859-20872, (2017)). Copolymers of AMA and a similar zwitterionic monomer, sulfobetaine methacrylate (SBMA), also formed a very similar morphology (Lounder, et al., Zwitterionic Ion-Selective Membranes with Tunable Subnanometer Pores and Excellent Fouling Resistance. Chemistry of Materials 33, 4408-4416, (2021)). Therefore, it was expected that upon casting, P(AMA-r-TFEMA-r-MPC) will self-assemble to form a similar morphology, resulting in a network of MPC-rich nanodomains that allow the permeation of water and solutes small enough to fit into these “nanochannels”, held together by the hydrophobic TFEMA/AMA-rich domains (FIG. 1A). After the formation of these TFC membranes, the hydrophobic AM repeat units were cross-linked using a thiol-ene click reaction with a dithiol (FIG. 1B). The un-crosslinked TERP-C-0 membrane was soaked in a solution of isopropanol:hexane mixture containing 2 wt % each of 2,2-dimethoxy-2-phenylacetophenone (DMPA, photoinitiator) and 1,6-hexanedithiol for 20 minutes. Afterwards, the membrane was exposed to UV light for various time periods ranging from 300 seconds to 14 minutes. The membranes were labelled TERP-C-5, TERP-C-10, TERP-C-12, and TERP-C-14 respectively, with the last two digits specifying the UV curing time (Table 2). During UV curing, DMPA, a photoinitiator, generated radicals from 1,6-hexanedithiol, which then reacted with the allylic double bonds of AM repeat units. This led to the cross-linking of the hydrophobic domains, increasing rigidity, and preventing the swelling of the zwitterionic nanochannels in aqueous environments to an extent related with the extent of reaction.

TABLE 2
Manufacturing conditions, permeances, and probe solute
rejections for TCZ membranes with varying UV exposure

| | | | VB12 | Riboflavin |
|---|---|---|---|---|
| | UV time | Permeance | rejection | rejection |
| Name | (min) | (L/m² · h · bar) | (%) | (%) |
| TERP-C-0 | 0 | 6.66 ± 0.45 | 87.5 | 18 |
| TERP-C-5 | 5 | 1.26 ± 0.20 | 98.7 | 65.4 |
| TERP-C-10 | 10 | 0.89 ± 0.03 | 99.4 | 70 |
| TERP-C-12 | 12 | 0.63 ± 0.06 | 99.7 | 75.6 |
| TERP-C-14 | 14 | 0.39 ± 0.07 | 99.8 | 78.7 |

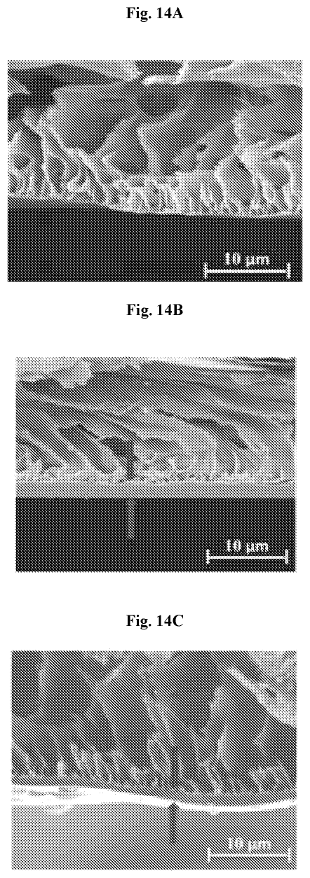

The morphology of cross-linked and uncross-linked TFC membranes was investigated by Scanning Electron Microscope (SEM) imaging (FIGS. 14A-14C). A thin selective layer on top of the support membrane is clearly visible in both TERP-C-0 and TERP-C-14 membranes. This layer thickness could potentially be further decreased by improving the coating processes, resulting in higher membrane permeance by up to 50 times. Importantly, FIG. 2c was acquired after the TERP-C-14 membrane was immersed in TFE, a solvent that easily dissolves uncross-linked P(AMA-r-TFEMA-r-MPC). The fact that the selective layer is visually unchanged shows that cross-linking improves the solvent stability of this layer. This opens the door to the potential future use of cross-linked ZAC membranes in additional applications, including solvent resistant nanofiltration and organic solvent nanofiltration (OSN).

### Membrane Permeance and Selectivity

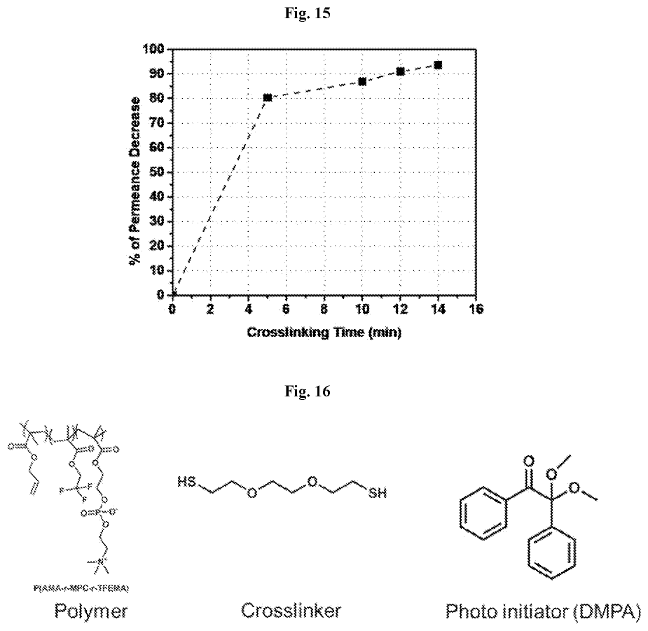

The performance of the newly manufactured membranes was characterized using dead-end stirred cell filtration (Table 3). The uncrosslinked TERP-C-0 membrane showed a pure water permeance of 6.66±0.45 L/m²·h·bar, similar to previous ZAC-based membranes. Membrane pure water permeance decreased with increasing cross-linking time, accompanied by a sharp increase in the rejection of various solutes (Table 3). A gradual increase in the UV curing time from 300 seconds to 14 minutes leads to a ˜93% decrease in pure water permeance compared with the un-crosslinked membrane (FIG. 15). This phenomenon implies that most of the available AMA groups were successfully crosslinked in that given time frame. These reaction times are significantly lower than other cross-linking chemistries such as photopolymerization of these allyl groups.

Membrane selectivity is considered as one of the most crucial parameters to determine their final performance and application in relevant sectors. The effect of UV irradiation on the selectivity of the crosslinked membranes was initially screened by following the rejection of two neutral small-molecule solutes, vitamin B12 (VB12; Stokes diameter 1.48 nm) and riboflavin (Stokes diameter ˜1 nm). The uncrosslinked TERP-C-0 membrane showed vitamin B12 and riboflavin rejections of 87.5% and 18%, respectively, consistent with earlier studies. Increasing UV exposure time led to increases in the rejections of both solutes, stabilizing after 12-14 minutes, consistent with the permeance data (Table 3).

P(AMA-r-TFEMA-r-MPC) does not have any functional groups, and is electrostatically neutral in nature. As a result, its selectivity was not expected to be heavily influenced by solute charge, exhibiting mostly size-based selectivity. To validate the size-selective nature of TERP-C-0 and TERP-C-14 membranes, the rejection of different dyes was investigated, with various numbers of negative charges (Table 3; FIG. 7A). This set of dyes was previously used, and was shown to be a good predictor of ZAC-based membrane selectivity. In this particular study, calculated diameters estimated from molecular volumes was used, because the Stokes radii of many of these dyes were not consistently reported in the literature. These calculated diameters were estimated by calculating the molecular volume of each molecule (Molecular Modeling Pro) and then calculating the diameter of a sphere of the same volume. As such, it is a significant underestimate that does not account for geometry or hydration. but it has established to be dependable and predictive of rejection curves of solutes by ZAC-based membranes. Both the uncrosslinked membrane TERP-C-0 and the highly cross-linked TERP-C-14 exhibit consistent rejections, with the rejection of each dye linked with its size independent of the number of anionic charges (FIG. 7A). This implies that charge does not significantly affect selectivity. The rejections of all dyes by TERP-C-14 were higher extent compared to that of uncrosslinked TERP-C-0, further confirming the decrease of effective pore size upon cross-linking.

TABLE 3
Name, size, charge, and absorbance wavelength of the
anionic dyes used in the filtration experiment

| Solute Name | Calculated diameter [nm] | Charge | λ[nm] |
|---|---|---|---|
| Brilliant blue R | 1.11 | −1 | 553 |
| Direct red 80 | 1.08 | −6 | 528 |
| Chicago sky blue 6B | 0.88 | −4 | 593 |
| Acid blue 45 | 0.84 | −2 | 595 |
| Ethyl orange | 0.82 | −1 | 474 |
| Methyl orange | 0.79 | −1 | 463 |

To demonstrate the ability of the TERP-C-14 membrane for small molecule mixture separation, an equimolar mixture (0.05 mM) of two dyes was filtered, methyl orange (0.79 nm) and Chicago Sky Blue 6B (0.88 nm). No trace of Chicago Sky Blue 6B could be seen in the permeate, evidenced by the lack of characteristic UV-visible spectrum peaks at 597 nm (FIG. 7C), suggesting that the membrane is fully capable of retaining the dye. Methyl orange was still be able to permeate through the membrane, demonstrating the fractionation of this solution mixture.

The quite small effective pore size of the highly cross-linked TERP-C-14 membrane led us to test its ability to separate ions, these cross-linked r-ZAC membranes that exhibit excellent anion selectivity due to a combination of steric effects and ion-zwitterion interactions. The rejection of mono- and di-valent anion salts of sodium, specifically NaCl, and Na₂SO₄, using 20 mM solutions at 3 and 4 bar trans-membrane pressure was measured (FIGS. 9A and 9B). Un-cross-linked TERP-C-0 membrane showed very low salt rejection (<10%), consistent with previous reports on other uncross-linked ZACs.³⁷ In only 5 minutes of UV exposure, salt rejection increased prominently, to ˜95% for Na₂SO₄ and to ˜20% for NaCl. Longer UV curing led to progressively but slowly increasing rejections for both salts. 14 minutes of cross-linking increased Na₂SO₄ rejection to 98%, and NaCl rejection to 32%. It is possible that even shorter UV exposures could lead to membranes with high salt selectivity, enabling fast and scalable manufacture.

### Fouling Resistance

Fouling is one of the greatest obstacles to the long term use of membranes in many important applications. Fouling is broadly defined by the accumulation and adsorption of various feed components on to the membrane surface, leading to performance loss. Managing fouling through regular cleanings and membrane replacement is one of the largest contributors to the cost of membrane operation. This makes fouling resistance highly desirable for new membrane materials. Membranes with various ZAC selective layers exhibit excellent resistance to fouling, completely resisting irreversible fouling even with highly challenging feeds. Consequently, the resistance of these thiol-ene cross-linked ZAC membranes was challenged against fouling by various foulant solutions. A state-of-the-art commercial nanofiltration membrane (NP-30) was also employed as a benchmark.

To characterize the fouling resistance, dead-end filtration experiments were performed. In each experiment, the initial pure water permeance was first measured by filtering deionized water until flux stabilizes. Then, the representative foulant solution is filtered for 20 hours. Afterwards, the membrane and filtration cell were cleaned several times with deionized water. Finally, deionized water was filtered again, to determine the reversibility of any permeance decline with only physical cleaning methods. to validate the reversibility of any fouling pure water permeance was re-measured. Disclosed crosslinked membrane exhibited high degree of removal of oil droplets. It was observed that the feed solution was translucent and grayish in colour due to light scattering by the oil droplets.

The first type of foulant studied was an oil-in-water emulsion. The oil and gas industry generates huge amounts of oily wastewater is consistently produced in the form of refinery wastewater, frac water, and produced water. To simulate these types of streams, a 1.5 h/L oil in water emulsion was used, prepared using a 9:1 ratio of soy bean oil to DC193 surfactant. Both the commercial NF membrane and TERP-C-14 effectively removed oil, generating a clear permeate, as expected. The commercial nanofiltration (NP-30) membrane (FIG. 12A) showed significant fouling, compromising almost ˜48% of its initial flux during foulant filtration. This irreversible flux loss was not recoverable through a simple physical cleaning process. This data is typical of the state-of-the-art membranes on the market today. In contrast, TERP-C-14 crosslinked membrane showed no significant flux loss even during the filtration of the oil emulsion. After the foulant filtration, with a simple water rinse, the pure water flux appeared as the same to its initial value. This trend is phenomenal, indicating superior anti-fouling characteristics of the crosslinked membrane whereas most reported membranes tend to show at least some flux loss during the filtration step.

The second series of fouling experiments were performed with bovine serum albumin (BSA), a well-known protein that is often used for characterizing the fouling propensity of membranes because of its strong tendency to easily adsorb on surfaces. The extent of fouling by BSA and other proteins is heavily affected by the solution composition, including the ionic strength, pH, and other solution properties. For this experiment, a 1 g/L BSA solution in 10 mM CaCl₂ (pH: 6.4) was used. Calcium ions can lead to gel formation through complexation with various anionic groups common in membrane materials, leading to increasing fouling propensity of the solution. Therefore, this solution is expected to constitute a particularly challenging foulant for membranes.

FIGS. 13A and 13B show the dead-end filtration of 1 g/L of BSA (bovine serum albumin) protein in 10 mM CaCl₂ solution by NP-30 (FIG. 13A) and TERP-C-14 (FIG. 13B). Similar to the oily water experiments, the commercial nanofiltration NP-30 membrane lost about 27% of its initial flux during foulant filtration. This irreversible flux loss was not recovered after pure DI water rinse. In contrast, no flux decline was seen during the filtration of this BSA solution through the TERP-C-14 membrane. The water fluxes before and after this fouling run were identical. This further demonstrates the improved fouling resistance of these zwitterionic membranes.

### Membrane Fabrication and Cross-Linking (P(AM-r-SBMA))

The cross-linkable ZAC in this work was a statistical/random copolymer of sulfobetaine methacrylate (SBMA), a zwitterionic monomer, and allyl methacrylate (AM), a hydrophobic monomer featuring a C═C double bond in its side-group that can undergo thiol-ene reactions. Through a thiol-ene reaction with a dithiol, the AM units are crosslinked (FIG. 1C, FIG. 1F). This cross-linking reaction, particularly when performed in a solvent/plasticizer that preferentially partitions into the hydrophobic domains, prevents the swelling of zwitterionic domains when immersed in water. As a result, the effective pore size of the cross-linked ZAC-based membrane in water is smaller than that of its un-cross-linked counterpart. The time scales required for cross-linking the hydrophobic phase were too long to be implemented in roll-to-roll manufacturing.

Activators regenerated by electron transfer atom transfer radical polymerization (ARGET-ATRP) was employed to synthesize P(AM-r-SBMA) (FIG. 1C). The lower reactivity of allyl groups in this controlled polymerization reaction scheme allowed to polymerize AM only through its more reactive methacrylate groups while keeping the allyl side-groups intact. This synthesis scheme is highly scalable, as ARGET-ATRP is a robust polymerization technique that enables the synthesis of designed polymers and copolymers at low temperatures without the need to remove water and protic species. ¹H NMR confirmed the active presence of allylic double bond (δ=5.3 ppm; δ=5.8 ppm) in the structure of P(AM-r-SBMA) (FIG. 1D). The overall SBMA content of the copolymer was calculated from this spectrum to be 47 wt %. This closely matches with our SBMA content in the reaction mixture. Given the relatively low conversion of 10%, the close match between copolymer and reaction mixture compositions implies a roughly random arrangement of AM and SBMA repeat units along the polymer backbone. While this low conversion was used in the presented data set to ensure the solution did not form a cross-linked gel, conversions over 50% have been achieved in subsequent experiments with similar cross-linkable copolymers containing AM and zwitterionic monomers without gelation. This indicates that this technique can be used in the future for reliable, scalable synthesis of this copolymer, without environmental impacts that significantly surpass most specialty polymer products. The prepared copolymer is a white solid, soluble in trifluoroethanol (TFE) and dimethylsulfoxide (DMSO).

The poor solubility of P(AM-r-SBMA) in common solvents limited use of gel permeation chromatography (GPC) to measure its molar mass. To estimate the relative molecular weight of the copolymer, dynamic light scattering (DLS) was performed on a dilute solution of the copolymer in TFE. The copolymer showed an effective hydrodynamic radius of 60.8±1 nm, corresponding to a molar mass of 2.6×10⁶ g mol⁻¹ based on polyacrylonitrile standards in dimethyl formamide. It is important to mention that the molecular weight represented here is a relative value of polymer segments having a comparable hydrodynamic radius. Polymer chain aggregation and polymer-solvent interactions heavily influence the relationship between absolute molar mass and hydrodynamic radius, though relative molar masses calculated by GPC also suffer from similar limitations. Therefore, this relatively high relative molar mass confirms that the synthesized copolymer is a longchain polymer.

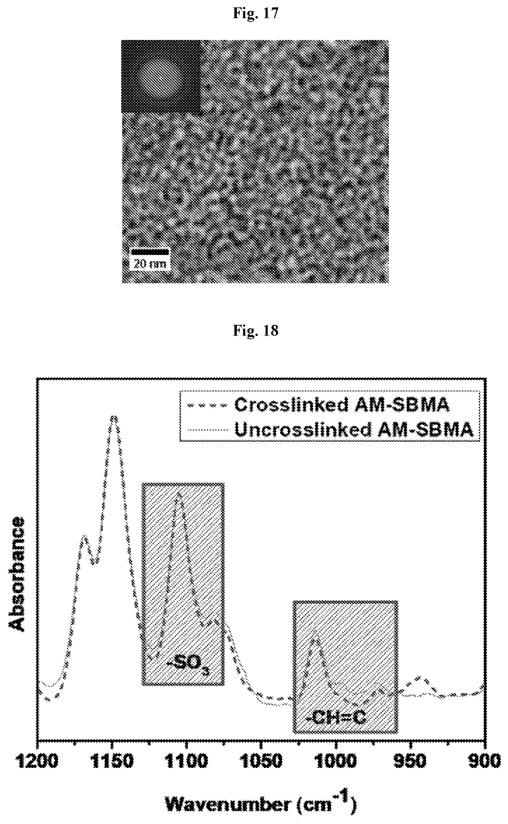

The self-assembled nanostructured morphology of the synthesized ZAC, P(AM-r-SBMA), was characterized using TEM. The zwitterionic nanodomains were positively stained by immersion in 2% aqueous CuCl₂ for four hours to stain the zwitterionic nanodomain, as sulfobetaine groups and copper (II) ions form stable complexes. As seen in the bright field TEM images in FIG. 17, P(AM-r-SBMA) self-assembles to form interconnected bicontinuous networks of hydrophobic (bright) and zwitterionic (dark) nanodomains. The dark zwitterionic domains are interconnected, showing a percolated network through the film that allows the permeation of water. Fast Fourier Transform (FFT) analysis (FIG. 17, inset) shows an average domain size of 1.4 nm. This morphology is similar to those observed for other ZACs.

P(AM-r-SBMA) was coated onto a commercial support membrane (Solecta, PS-35) to form a TFC membrane. For this purpose, P(AM-r-SBMA) was dissolved in TFE to form a 5 wt % solution, which was coated on top of the support by using a wire-wound metering rod. This coated membrane was placed in an oven preheated to 65° C. for 12 min. Finally, the membrane was taken out of the oven and immediately immersed in DI water overnight. This TFC membrane, as fabricated and without any cross-linking, is termed TCZ-0. Upon casting, the self-assembly of the ZAC led to the formation of a network of zwitterionic nanodomains that allow the permeation of water and solutes small enough to enter the zwitterionic nanochannels, held together by the hydrophobic AM-rich domains (FIG. 17).

After the formation of these TFC membranes, the hydrophobic AM repeat units were cross-linked using a thiol-ene click reaction with a dithiol (FIG. 1C). Un-cross-linked TCZ-0 membrane was soaked in a solution of IPA containing 1 wt % each of DMPA (photoinitiator) and 1,6-hexanedithiol for 10 min. Afterwards, the membrane was exposed to UV light for various time periods ranging 10-40 s. The membranes are identified as TCZ-10, TCZ-20, TCZ-30, and TCZ-40 respectively, with the last two digits specifying the UV curing time in seconds. During UV curing, DMPA acted as a photoinitiator and generated radicals on 1,6-hexanedithiol, which then reacted with the allylic double bonds of AM repeat units (FIG. 1F). This led to the cross-linking of the hydrophobic domains, increasing rigidity and preventing the swelling of the zwitterionic nanochannels in aqueous environments as determined by the extent of reaction.

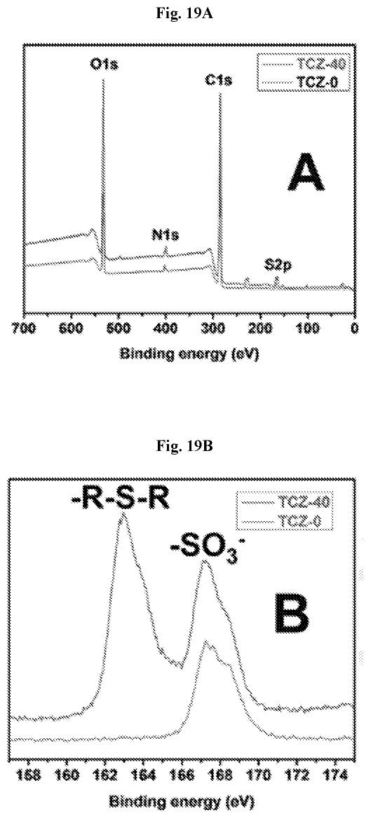

The cross-linking of the selective layer was confirmed by analyzing the chemical composition of the selective layer using ATR-FTIR spectroscopy (FIG. 18). Most peaks corresponding to SBMA groups and the backbone, including sharp peaks at ≈1150 and ≈1070-1090 cm−1 associated with C—O—C and —SO₃-stretching, remained similar in both TCZ-0 and TCZ-40 membranes as expected. The main difference between the spectra was the intensity of the peak responsible for —CH═C bending (985-1004 cm⁻¹). The decreased peak intensity for TCZ-40 membrane compared to TCZ-0 can be attributed to the consumption of the allyl double bonds through the thiol-ene cross-linking upon UV curing.

The surface elemental compositions of these two membranes were further characterized using XPS (FIGS. 19A-19B). Characteristic peaks for O1s, N1s, C1s, and S2p are present in survey spectra for both membranes (FIG. 19A), in good agreement with the selective layer elemental compositions. High-resolution spectra for the S2p region (FIG. 19B) allowed deeper characterization of the binding structures around sulfur groups. The TCZ-0 membrane showed only one S2p peak (168.2 eV), arising from the SO₃⁻ groups on the SBMA repeat units. The spectrum for the cross-linked TCZ-40 membrane exhibited two different S2p peaks, one at 163.5 eV and the other at 168.2 eV. The additional peak was associated with the thioether groups (R—S—R) formed upon the thiol-ene click reaction. These results further confirm the expected cross-linking reaction.

The morphology of coated membranes was investigated by SEM imaging (FIGS. 2A-2C). A thin selective layer on top of the support membrane is clearly visible in both TCZ-0 and TCZ-40 membranes. This layer adheres to the support through partial penetration of the polymer into the fine pores of the support, forming a physical anchor, as well as through intermolecular interactions. Upon cross-linking, there is also likely some chemical bonding between the support and the layer, as polysulfone is known to generate free radicals that can react with allyl groups in the copolymer upon UV irradiation. This layer thickness could potentially be further decreased by improving the coating processes, resulting in higher membrane permeances by up to 50 times, as demonstrated with other ZAC membrane chemistries.

Membrane was immersed in TFE, a solvent that readily dissolves un-cross-linked P(AM-r-SBMA). The fact that the selective layer is visually unchanged shows that cross-linking improves the solvent stability of this layer. This opens the door to the potential future use of cross-linked ZAC membranes in additional applications, including solvent-resistant nanofiltration and organic solvent nanofiltration (OSN).

### Membrane Permeability and Selectivity

Membrane performance was characterized using deadend stirred cell filtration experiments (Table 4).

TABLE 4
Manufacturing conditions, permeances, and probe solute rejections
for TCZ membranes with varying UV exposure times

| | UV | | VB12 | Riboflavin |
|---|---|---|---|---|
| | exposure | Permeance | rejection | rejection |
| Name | time [s] | [L m⁻² · h · bar] | [%] | [%] |
| TCZ-0 | 0 | 5.5 ± 0.9 | 82.1 ± 0.3 | 32.9 ± 0.2 |
| TCZ-10 | 10 | 3.7 ± 0.3 | 94.5 ± 0.2 | 47.3 ± 0.1 |
| TCZ-20 | 20 | 2.3 ± 0.3 | 96.3 ± 0.1 | 54.2 ± 0.2 |
| TCZ-30 | 30 | 1.5 ± 0.4 | 99.5 ± 0.1 | 73.5 ± 0.1 |
| TCZ-40 | 40 | 1.2 ± 0.2 | 99.7 ± 0.1 | 74.2 ± 0.1 |

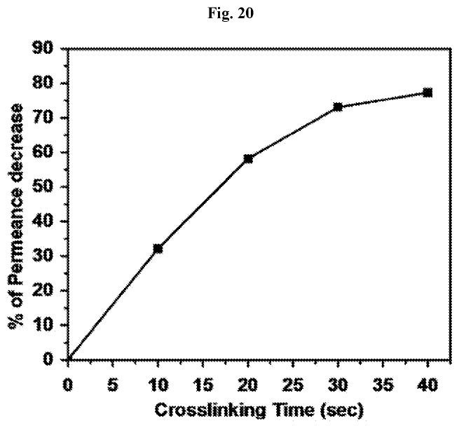

The average permeance of the un-cross-linked TCZ-0 membrane was 5.5±0.9 L m⁻²·h·bar. The cross-linking of the hydrophobic domains of P(AM-r-SBMA) lead to a decrease in the effective pore size, as demonstrated by a decrease in water permeance along with an increase in the rejection of solutes. Increasing UV curing time from 10 to 40 s leads to a permeance decrease of ≈80% compared to the un-cross-linked system (FIG. 20), with the change plateauing at only ≈30-40 s exposure time. This trend implies close to complete cross-linking of available AM groups in less than a minute, an order of magnitude less than necessary using other cross-linking chemistries such as photo polymerization of these allyl groups.

One of the most crucial parameters of membranes is their selectivity. As an initial screen to characterize how UV irradiation time affected the selectivity of these membranes, two neutral small-molecule solutes were used, vitamin B12 (VB12; Stokes diameter 1.48 nm) and riboflavin (Stokes diameter ≈1 nm), as probes. The rejections of vitamin B12 and riboflavin by the TCZ-0 membrane were 82% and 33%, respectively, consistent with previous studies. The rejections of both solutes increased with increasing exposure time, stabilizing once again after 30-40 s, consistent with the permeance results (Table 4).

The selectivity of un-crosslinked ZAC membranes is dominated by solute size. As the synthesized zwitterionic copolymer is electrostatically neutral, membrane selectivity is not heavily affected by solute charge, with charged and neutral solutes of roughly similar geometry sharing a rejection curve along with low salt rejections. To characterize the size-based selectivity of TCZ-0 and TCZ-40 membranes, the rejection of various negatively charged dyes was measured (Table 1). It should be noted that the calculated diameters that were used here are not Stokes diameters, but an estimate of molecular size calculated from molecular volume, acquired using Molecular Modelling Pro software. This measure is an underestimate of the actual Stokes diameters as it does not account for hydration or molecular geometry effects, but it has proven to be reliable and predictive of rejection properties of solutes by ZAC-based membranes.

FIG. 4 shows the rejection of different anionic dyes by TCZ-0 and TCZ-40 membranes. The rejection of different anionic dyes with varying charges fit into a single rejection curve for both the membrane TCZ-0 and TCZ-40 (FIG. 4), implying limited charge effects as discussed earlier. The TCZ-40 membrane rejects all dyes to a higher extent than TCZ-0 does, further confirming the decrease in effective pore size. The final rejections of these dyes are all above 85%, implying very small pores that may potentially exhibit salt rejection based on steric effects and also zwitterion-ion interactions.

To demonstrate the ability of the TCZ-40 membrane to separate dye mixtures, we filtered a solution containing a mixture of two dyes, Chicago Sky Blue 6B (0.88 nm) and methyl orange (0.79 nm), at the same concentration (0.05 mM). The obtained permeate contained no Chicago Sky Blue 6B, documented by the UV-visible spectrum lacking the characteristic peak of this dye at 597 nm (FIG. 6). Methyl orange still permeated through the membrane, demonstrating the fractionation of this mixture.

The stability of these membranes in strong acids and bases was tested, often used for chemical cleanings. The permeance and Vitamin B12 rejection of one of the thiol-ene cross-linked ZAC membranes, TCZ-20, did not change measurably after immersion in either 0.5 M NaOH or 0.5 M HCl for 24 hours (FIG. 22). This confirms the chemical stability of these selective layers. These membranes feature selective layers fabricated from the cross-linkable ZAC poly(allyl methacrylate-random-sulfobetaine methacrylate) (P(AM-r-SBMA)), whose chemical structure is shown in FIG. 1C. UV exposure times >5 min to observe any change; further increases in exposure time lead to smaller pore size. The important feature of this work is the utilization of a new cross-linking chemistry, thiolene click chemistry with a dithiol, to decrease the UV exposure time down to seconds. Cross-linking for only 10 seconds led to significant changes in pore size, and varying exposure time between 10 and 40 s was shown to further tune the effective pore size, salt rejections, and mono-/divalent ion selectivity. Resultant membranes exhibited high Cl⁻/SO₄²⁻ selectivities compared with many state-of-the-art membranes (Table 5).

TABLE 5
Cl⁻/SO₄²⁻ selectivity comparison of highly cross-linked
P(AMA-r-SBMA) membranes (TCZ-X) against other membranes.
All membranes were tested at room temperature. Feed solution
compositions refer to individual salt solutions.

| | Cl⁻ | SO₄²⁻ | |
|---|---|---|---|
| Membrane | Rejection | Rejection | Feed Component |
| TCZ-X (this | 28.6 | 83.2 | Cl⁻: 20 mM NaCl |
| work) | | | SO₄²⁻: 20 mM Na₂SO₄ |
| RCP Micelles [1] | 16.6 | 30.5 | Cl⁻: 10 mM NaCl |
| | | | SO₄²⁻: 10 mM Na₂SO₄ |
| ZCNT/PA [2] | 9 | — | Cl⁻: 70 mM NaCl |
| | | | SO₄²⁻: 70 mM Na₂SO₄ |
| ZNP/PA [3] | 9.3 | — | Cl⁻: 1000 ppm NaCl |
| | | | SO₄²⁻: 1000 ppm Na₂SO₄ |
| GO/TMC [4] | 19 | 46 | Cl⁻: 20 mM NaCl |
| | | | SO₄²⁻: 10 mM Na₂SO₄ |
| Charged PEO [5] | 52 | 89 | Cl⁻: 10 mM NaCl |
| | | | SO₄²⁻: 10 mM Na₂SO₄ |
| PRP/TMC [6] | 7-10 | 5-20 | Cl⁻: 2 g/L NaCl |
| | | | SO₄²⁻: 2 g/L MgSO₄ |
| mMSN/PA [7] | 29 | 80 | Cl⁻: 5 mmol/L NaCl |
| | | | SO₄²⁻: 5 mmol/L Na₂SO₄ |
| MPD-HOMCs/TMC | 50 | 87 | Cl⁻: 2000 ppm NaCl |
| [8] | | | SO₄²⁻: 2000 ppm Na₂SO₄ |
| NFG^{a} | 10 | 50 | NaCl/MgSO₄ (feed not |
| | | | reported) |

^{a}Nanofiltration (NF) Membranes - Flat Sheet Membranes; https://www.sterlitech.com/nanofiltration-nf-membrane.html

As mentioned herein, rejections of even the smallest probe dyes by TCZ-40 are quite high. This implies extremely small pores that may exhibition selectivity. As discussed in a recent study, membranes with highly cross-linked ZAC selective layers exhibit anion selectivity associated with steric effects as well as zwitterion-ion interactions. Therefore, it is reasonable to expect selectivity between salt ions in the thiol-ene cross-linked membranes discussed here. To test this hypothesis, we measured the rejection of various salts, specifically NaCl, MgSO₄, and Na₂SO₄, using 20 mM solutions at 2-4 bar transmembrane pressure (FIGS. 8A-8C). Un-cross-linked TCZ-0 membrane exhibited very low salt rejection (<20% for all salts) and separation factors very close to 1 (Table 6), consistent with previous un-cross-linked ZAC membranes. UV curing led to increased rejection of all four salts, though the patterns in these changes depended on the nature of each salt. In as little as 10 s UV exposure, we observed significant increases to salt rejection due to cross-linking. Such rapid tuning of selectivity is unique to this system, enabled by the high reaction rates in thiol-ene chemistry as well as the unique separation mechanisms in ZAC-based membranes.

TABLE 6
NaCl/Na₂SO₄ separation factor comparison of
highly cross-linked P(AMA-r-SBMA) membranes
(TCZ-X) against different applied pressure

| Membrane Name | 2 Bar pressure | 3 Bar pressure | 4 Bar pressure |
|---|---|---|---|
| TCZ-0 | 1.0 | 1.1 | 1.2 |
| TCZ-10 | 3.1 | 3.3 | 3.2 |
| TCZ-20 | 3.4 | 3.4 | 3.6 |
| TCZ-30 | 3.6 | 3.5 | 3.7 |
| TCZ-40 | 3.8 | 3.7 | 4.3 |

All membranes were tested at room temperature. Separation factor is defined as the ratio between the passage rates of Cl⁻ and SO₄²⁻ ions, calculated by the following formula:

$$\\ Separation factor = \frac{100 - {R}_{NaCl}}{100 - {R}_{{Na}_{2} {SO}_{4}}}$$

Where RNaCl is the rejection of NaCl, and RNa₂SO₄ is the rejection of Na₂SO₄ ions. In other words, a high separation factor corresponds to a lower rejection of chloride, and a higher rejection of sulfate when the same counterion is present.

The most significant change for the shortest time periods was for Na₂SO₄, whose rejection at 2 bars increased from ≈4% to ≈70% upon only 10 s of exposure. Na2SO4 rejection did not increase as prominently with further cross-linking, with 78% rejection after 40 s. Interestingly, the rejection of Na₂SO₄ was consistently higher than that of MgSO₄, though this difference was more pronounced for the shortest exposure times of 10 and 20 s. MgSO₄ rejection also increased more gradually, and comparatively stabilized after 30-40 s, similar to the trends for permeance and organic solute rejections. Size-based selectivity is a contributor to these trends, but the fact that cross-linked ZAC membranes can, under some circumstances, exhibit selectivity between ions of similar charge and size implies zwitterion-ion interactions also play a significant role. In other words, both the size of ions and their affinity to SBMA affect selectivity. In this case, the difference in trends may arise from differences in cation partitioning into the zwitterionic nanochannels, which also affects sulfate permeability due to electroneutrality. At higher degrees of cross-linking, magnesium rejection increases due to size exclusion.

The rejection of NaCl increased much less substantially with cross-linking time than the rejection of Na₂SO₄ and MgSO₄, reaching a maximum of 29% after 40 s of cross-linking. As a result, the NaCl/Na₂SO₄ separation factor increased with increasing irradiation time (Table 6). The largest jump was observed within 10 s, with the separation factor mostly plateauing by 40 s. As a result, these thiol-ene crosslinked membranes have highly tunable mono-/divalent ion selectivity along with rapid and facile fabrication. For instance, membranes cross-linked for shorter times (e.g., TCZ-10) may remove divalent anions with limited cation separation, whereas highly cross-linked membranes (e.g., TCZ-40) can be used to selectively remove all divalent ions with comparatively low NaCl rejection.

### Fouling Resistance

Fouling, associated with the adsorption and accumulation of feed components on the membrane surface, is one of the most significant barriers that prevent the broader use of membranes in many applications. Therefore, novel membranes should resist fouling by preventing the adsorption of organic foulants on their surface. ZAC membranes have proven to exhibit unmatched fouling resistance due to the presence of highly hydrated zwitterionic groups covering their surfaces.

We tested the resistance of these thiol-ene cross-linked ZAC membranes to fouling by various foulants. A commercial state-of-the-art nanofiltration membrane (NP-30) was also used as a benchmark to compare the fouling data with our cross-linked membrane.

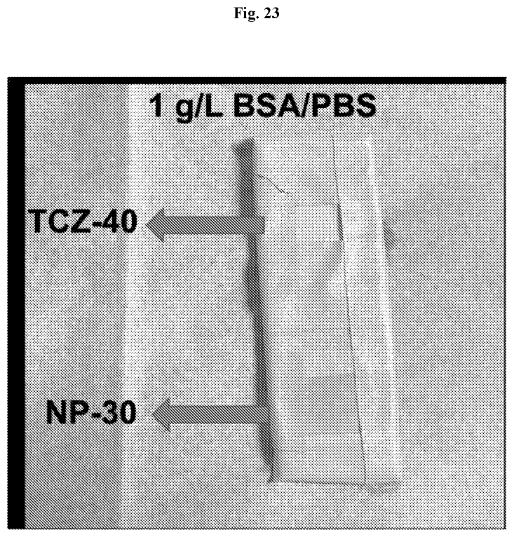

We performed a static fouling experiment, which involved immersing both a thiol-ene cross-linked ZAC membrane, TCZ-40, in a solution of the protein bovine serum albumin (BSA) in phosphate buffer saline (PBS). BSA is frequently used for testing the fouling propensity of membranes due to its tendency to easily adsorb on surfaces. After 24 h in this solution, the membranes were removed and rinsed with DI water. Then, the proteins adsorbed on the membranes were stained using Gelcode Blue Safe Protein Stain. The darker blue color on the fouled NP30 membrane indicated significant protein adsorption, whereas little if any blue staining was observed on the TCZ-40 membrane (FIG. 23). This indicated that the cross-linked ZAC membrane TCZ-40 experienced minimal if any protein fouling, outperforming the commercial membrane in terms of fouling resistance, even in this simplified system.

While the static fouling experiment is promising, membrane fouling during operation is much more complex. Fouling can occur with a broad range of chemical species depending on the feed, and concentration polarization and hydrodynamics during filtration further enhance fouling propensity. Therefore, the majority of our fouling analysis utilized dead-end stirred cell filtration experiments, often considered a worst-case scenario for fouling due to the progressive accumulation of the foulant in the filtration cell. We also screened multiple foulants.

The first foulant selected was an oil-in-water emulsion. An enormous amount of oily wastewater is regularly produced by the oil and gas industry in the form of produced water, frac water, and refinery wastewater. Proper disposal of these wastewater streams remains a critical issue. Therefore, we challenged two of our cross-linked membranes (TCZ-30 and TCZ-40) with 1.5 g/L oil-in-water emulsions with a 9:1 ratio of soybean oil to DC193 surfactant, selected to represent such oily wastewater streams.

FIGS. 10A-10C shows data from oil-in-water emulsion fouling experiments performed in dead-end stirred cell filtration mode for TCZ-30 (FIG. 10A), TCZ-40 (FIG. 10B) and the commercial nanofiltration membrane NP-30 (FIG. 10C). In each case, after filtering deionized water to determine the initial pure water permeance, the foulant solution was filtered for 20 h. Then, the filtration cell and membrane were rinsed several times with water, simulating physical cleaning by a forward flush with clean water. Then, pure water permeance was measured again to determine the reversibility of any fouling. All three membranes exhibited high removal of oil droplets, as indicated by the appearance of the feed and the permeate. While the feed was translucent and greyish due to light scattering by the droplets, the permeate was clear. FIG. 10A (inset) demonstrates this for the TCZ-30 membrane. Permeates from the other three membranes were similar.

During the fouling experiments, both TCZ-30 and TCZ-40 membranes showed no significant decline in flux even during foulant filtration. After the water rinse, the pure water flux remains identical to the initial value. This performance is exceptional, as most membranes show at least some flux decline during the filtration step. The data obtained from the commercial NP-30 membrane (FIG. 10C) is more representative of the state-of-the art. This membrane fouled significantly, losing almost ≈48% of its initial flux during foulant filtration. This loss was not reversible through a physical cleaning process.

We also performed fouling experiments with two feeds that included BSA. The fouling potential of BSA and other proteins heavily depends on the solution properties, including ionic strength and pH. Therefore, we prepared 1 g L⁻¹ solution in BSA in two different matrices. The first involved BSA dissolved in PBS (phosphate buffered saline), a quite common system for initial fouling screening in the literature. As an additional challenge, we prepared a 1 g/L solution of BSA in 10 mM CaCl2 (pH: 6.4). Calcium ions have a tendency to form gels through complexation with multiple anions, leading to a high fouling propensity of the solution.

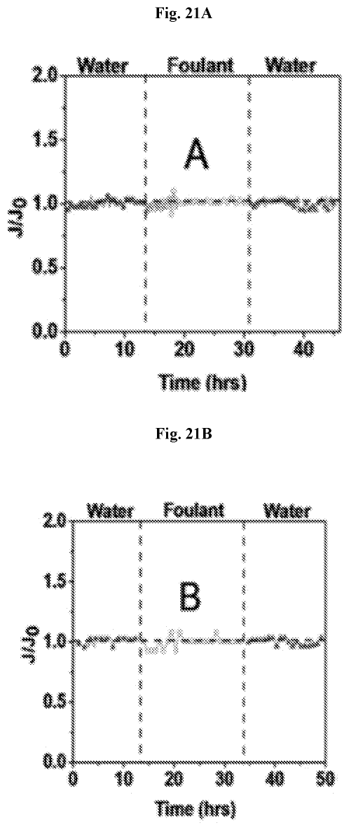

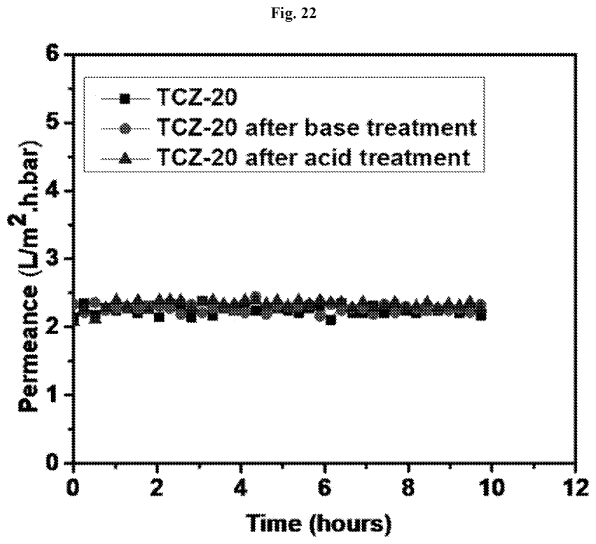

FIGS. 21A-21B shows the dead-end filtration of 1 g L−1 of BSA protein in PBS by TCZ-30 (FIG. 21A) and TCZ-40 (FIG. 21B). The foulant solution was filtered through both the membranes for 18 h. No decline in the flux was observed during foulant filtration for either membrane. No irreversible flux loss was measured after a gentle water rinse. This phenomenon clearly shows the exceptional fouling resistance of these ZAC membranes.

In addition, we also studied the fouling of these membranes using a more challenging protein solution as described above, 1 g L⁻¹ of BSA in 10 mM CaCl2 solution for 20 h (FIGS. 11A-11B). The TCZ-40 membrane showed negligible flux decrease during foulant filtration over 20 h, which was completely recovered after a simple water rinse. In contrast, commercial NP-30 showed almost 27% of its initial flux decline during foulant filtration. This irreversible flux loss was not recovered after the water rinse.

These experiments demonstrate improved degree of fouling resistance this new family of membranes exhibits, even with challenging feeds. Any minimal membrane flux loss during foulant filtration can be easily recovered by physical cleaning, i.e., rinsing with water. This degree of fouling resistance, where membrane flux is mostly retained even during the dead-end filtration of highly fouling feeds, has only been matched by other ZAC-based membranes, greatly surpassing the state-of-the-art.

A rapid thiol-ene click cross-linking strategy was developed to tune in the selectivity of prepared ZAC membranes. This facilitates comparatively rapid manufacturing of highly crosslinked ZAC membranes in an efficient scalable manner for roll-to-roll industrial scale up. This demonstrates the wide scalable use of thiol-ene click chemistry to significantly alter the porosity of a self-assembled nanofiltration membrane. The increasing UV exposure times between 5 to 14 minutes showed high ion and small molecule rejection, with a remarkable change between 0 and 300 seconds, validates that the rate of reaction was super-fast even at a shorter time scale. TERP-C-14, the maximum crosslinked membrane, showed outstanding mono-/divalent selectivity. On the other hand, phenomenal anti-fouling characteristics were shown by the as fabricated cross-linked membranes, which is necessary for long-term operation. Dead-end filtration of oil/water emulsion or BSA protein rejection showed no irreversible flux loss. These key findings corroborate the potential usage of these highly crosslinked ZAC-based membranes for various industries, ranging from water softening, biomolecule separations, textile wastewater treatment, and sulphate removal from seawater for oil drilling etc. In addition, the versatility and functional group tolerance of the thiol-ene click chemistry allowed us to design and fabricate novel class of cross-linked random zwitterionic copolymer membranes for a wide range of applications.

### INCORPORATION BY REFERENCE

All U.S. and PCT patent publications and U.S. patents mentioned herein are hereby incorporated by reference in their entirety as if each individual patent publication or patent was specifically and individually indicated to be incorporated by reference. In case of conflict, the present application, including any definitions herein, will control.

### OTHER EMBODIMENTS

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

We claim:

1. A crosslinked copolymer network, comprising:
a copolymer, comprising a plurality of zwitterionic repeat units, and a plurality of a first type of hydrophobic repeat units;
a plurality of crosslinking units; and
a plurality of crosslinks;
wherein each crosslinking unit comprises a first terminal thiol moiety and a second terminal thiol moiety; each hydrophobic repeat unit comprises an alkene; and each crosslink is formed from (i) the first terminal thiol moiety of a crosslinking unit and the alkene of a first hydrophobic repeat unit, and (ii) the second terminal thiol moiety of the crosslinking unit and the alkene of a second hydrophobic repeat unit.

2. The crosslinked copolymer network of claim 1, wherein each of the zwitterionic repeat units independently comprises sulfobetaine, carboxybetaine, phosphorylcholine, imidazolium alkyl sulfonate, or pyridinium alkyl sulfonate.

3. The crosslinked copolymer network of claim 1, wherein each of the zwitterionic repeat units is independently formed from sulfobetaine acrylate, sulfobetaine acrylamide, carboxybetaine acrylate, carboxybetaine methacrylate, 2-methacryloyloxyethyl phosphorylcholine, acryloxy phosphorylcholine, phosphorylcholine acrylamide, phosphorylcholine methacrylamide, carboxybetaine acrylamide, 3-(2-vinylpyridinium-1-yl)propane-1-sulfonate, 3-(4-vinylpyridinium-1-yl)propane-1-sulfonate, or sulfobetaine methacrylate.

4. The crosslinked copolymer network of any one of claims 1-3, wherein each of the hydrophobic repeat units is independently formed from a styrene, an alkyl acrylate, an alkyl methacrylate, an alkyl acrylamide, an acrylonitrile, an aryl acrylate, an aryl methacrylate, and an aryl acrylamide.

5. The crosslinked copolymer network of any one of claims 1-4, wherein the copolymer is poly((allyl methacrylate)-random-(sulfobetaine methacrylate)) or poly((allyl methacrylate)-random-(2-methacryloyloxyethyl phosphorylcholine)), poly ((allyl methacrylate)-random-(trifluoroethyl methacrylate)-random-(sulfobetaine methacrylate)) or poly((allyl methacrylate)-random-(trifluoroethyl methacrylate)-random-(2-methacryloyloxyethyl phosphorylcholine)).

6. The crosslinked copolymer network of any one of claims 1-5, further comprising a plurality of a second type of hydrophobic repeat units, wherein the second type of hydrophobic repeat units are each independently formed from an alkyl acrylate, a alkyl methacrylate, an alkyl acrylamide, an acrylonitrile, an aryl acrylate, an aryl methacrylate, and an aryl acrylamide.

7. The crosslinked copolymer network of claim 6, wherein the second type of hydrophobic repeat units are formed from 2,2,2-trifluoroethyl methacrylate.

8. The crosslinked copolymer network of claim 7, wherein the copolymer is poly(allyl methacrylate-random-trifluoroethyl methacrylate-random-2-methacryloyloxyethyl phosphorylcholine).

9. The copolymer network of any one of claims 1-8, wherein the copolymer has a molecular weight of about 3,000 to about 10,000,000 Dalton.

10. The crosslinked copolymer network of claim 9, wherein the copolymer has a molecular weight of about 5,000 to about 500,000 Dalton.

11. The copolymer network of any one of claims 1-10, wherein the zwitterionic repeat units and the hydrophobic repeat units each constitute 20-80% by weight of the copolymer.

12. The crosslinked copolymer network of claim 11, wherein the zwitterionic repeat units constitute 25-75% by weight of the copolymer, and the hydrophobic repeat units constitute 25-75% by weight of the copolymer.

13. The copolymer network of any one of claims 1-12, wherein the copolymer is poly((allyl methacrylate)-random-(sulfobetaine methacrylate)), the zwitterionic repeat units constitute 25-75% by weight of the copolymer, and the copolymer has a molecular weight of about 20,000 to about 100,000 Dalton.

14. The crosslinked copolymer network of any one of claims 1-13, wherein the plurality of crosslinking units is represented by FG-CL-FG, wherein FG is a linker-thiol moiety, and CL is a C₁-C₂₀ bivalent aliphatic radical, a C₁-C₂₀ bivalent heteroaliphatic radical, a bivalent aryl radical, or a bivalent heteroaryl radical.

15. The crosslinked copolymer network of claim 14, wherein CL is a C₁-C₂₀ bivalent aliphatic radical or a C₁-C₂₀ bivalent heteroaliphatic radical.

16. The crosslinked copolymer network of claim 14, wherein FG-CL-FG is —S—(CH₂)₆—S—, or —S—(CH₂)₂—O—(CH₂)₂—O—(CH₂)₂—S—.

17. A thin film composite membrane, comprising a porous substrate, and a selective layer comprising the crosslinked copolymer network of claim 1, wherein an average effective pore size of the porous substrate is larger than an average effective pore size of the selective layer; and the selective layer is disposed on a surface of the porous substrate.

18. The thin film composite membrane of claim 17, wherein the selective layer has the average effective pore size of about 0.1 nm to about 2.0 nm.

19. The thin film composite membrane of claim 17, wherein the selective layer has the average effective pore size of about 0.1 nm to about 1.2 nm.

20. The thin film composite membrane of claim 17, wherein the selective layer has the average effective pore size of about 0.7 nm to about 1.2 nm.

21. The thin film composite membrane of any one of claims 17-20, wherein the selective layer has a thickness of about 10 nm to about 10 μm.

22. The thin film composite membrane of claim 21, wherein the selective layer has the thickness of about 100 nm to about 2 μm.

23. The thin film composite membrane of any one of claims 17-22, wherein the thin film composite membrane rejects charged solutes and salts.

24. The thin film composite membrane of claim 23, wherein the selective layer exhibits sulfonate (SO₄²⁻) rejection of greater than 95%.

25. The thin film composite membrane of claim 23 or 24, wherein the selective layer exhibits chloride (Cl⁻) rejection of less than 35%.

26. The thin film composite membrane of claim 25, wherein the selective layer exhibits sulfonate (SO₄²⁻)/chloride (Cl−) separation factor of greater than 50.

27. The thin film composite membrane of claim 26, wherein the selective layer exhibits sulfonate (SO₄²⁻)/chloride (Cl−) separation factor of about 75.

28. The thin film composite membrane of any one of claims 17-27, wherein the selective layer exhibits different anion rejections for salts with the same cation.

29. The thin film composite membrane of any one of claims 17-28, wherein the selective layer exhibits different anion rejections for salts selected from NaF, NaCl, NaBr, NaI, Na₂SO₄, and NaClO₄.

30. The thin film composite membrane of any one of claims 17-29, wherein the selective layer exhibits different rejections for different anionic dyes.

31. The thin film composite membrane of any one of claims 17-23, wherein the selective layer exhibits a Chicago Sky Blue 6B/methyl orange separation factor of about 10.

32. The thin film composite membrane of any one of claims 17-23, wherein the selective layer exhibits Vitamin B12 rejection of greater than about 95%.

33. The thin film composite membrane of any one of claims 17-23, wherein the selective layer exhibits Riboflavin rejection of greater than about 35%.

34. The thin film composite membrane of any one of claims 17-33, wherein the selective layer exhibits antifouling properties.

35. The thin film composite membrane of any one of claims 17-34, wherein the selective layer exhibits resistance to fouling by an oil emulsion.

36. The thin film composite membrane of any one of claims 17-34, wherein the selective layer exhibits resistance to fouling by a Bovine Serum Albumin solution.

37. The thin film composite membrane of any one of claims 17-35, wherein the selective layer is stable upon exposure to chlorine bleach.

38. The thin film composite membrane of any one of claims 17-37, wherein the selective layer exhibits size-based selectivity between uncharged organic molecules.

39. The thin film composite membrane of claim 38, wherein the selective layer exhibits rejection of >95% or >99% for neutral molecule with hydrated diameter of about or greater than 1.5 nm.

40. A method of making the crosslinked copolymer network of claim 1, the method comprising:
providing a copolymer comprising a plurality of zwitterionic repeat units, and a plurality of a first type of hydrophobic repeat units; wherein each hydrophobic repeat unit comprises an alkene, and
providing a plurality of crosslinking units; wherein each crosslinking unit comprises a first terminal thiol moiety and a second terminal thiol moiety;
providing a photo initiator, and
admixing the copolymer, the plurality of crosslinking units, and the photo initiator, thereby forming a mixture; and
irradiating the mixture with UV light, thereby forming the crosslinked copolymer.

41. The method of claim 40, wherein the mixture further comprises a solvent.

42. The method of claim 41, wherein the solvent is mixture of isopropanol and hexane.

43. The method of any one of claims 40-42, wherein the irradiation is performed at room temperature.

44. The method of any one of claims 38-43, wherein the photo initiator is 2-phenylacetophenone.

45. The method of any one of claims 40-43, wherein the irradiation is performed for about 10 seconds to about 20 minutes.

46. The method of claim 45, wherein the irradiation is performed for about 30 seconds.

47. The method of claim 45, wherein the irradiation is performed for about 60 seconds.

48. The method of claim 45, wherein the irradiation is performed for about 90 seconds.

49. The method of claim 45, wherein the irradiation is performed for about 120 seconds.

50. A method of pharmaceutical manufacturing, comprising:
contacting the thin film composite membrane of any one of claims 17-39 with a mixture comprising one or more pharmaceutical compounds; and
separating one or more pharmaceutical compounds via size-selective filtration.

51. A method of textile dying and processing, comprising:
contacting the thin film composite membrane of any one of claims 17-39 with a mixture comprising one or more textile dyes; and
separating one or more textile dyes via size-selective filtration.

52. A method of buffer exchange, comprising:
contacting the thin film composite membrane of any one of claims 17-39 with a first buffer solution; and
replacing the first buffer solution with a second buffer solution.

53. A method of purifying a peptide, comprising:
contacting the thin film composite membrane of any one of claims 17-39 with a mixture comprising one or more peptides; and
separating one or more peptides via size-selective filtration.

54. A method of removing a divalent ion from water, comprising:
contacting the thin film composite membrane of any one of claims 17-39 with an aqueous mixture comprising a divalent ion; and
removing some or all of the diavalent ion from the aqueous mixture via size-selective filtration.

55. A method of removing an organic solute from water, comprising:
contacting the thin film composite membrane of any one of claims 17-39 with an aqueous solution comprising an organic solute; and
separating the organic solute via size-selective filtration.

56. A method of removing disease-causing microorganisms, comprising:
contacting the thin film composite membrane of any one of claims 17-39 with an mixture comprising one or more disease-causing microorganisms; and
separating the one of more disease-causing microorganisms via reverse osmosis.

57. A method of size-selective separation, comprising:
contacting the thin film composite membrane of any one of claims 17-39 with a mixture comprising one or more particles of differing sizes; and
separating one or more particles via size-selective filtration.

58. A method of processing food, comprising:
contacting the thin film composite membrane of any one of claims 17-39 with a impure food ingredient; and
separating a contaminant from the impure food ingredient via size-selective filtration.

59. A method of printing, comprising:
contacting the thin film composite membrane of any one of claims 17-39 with one or more ink; and
applying the one or more ink to a surface of an article.
